(19) United States
(12) Patent Application Publication
(10) Pub. No.: US 2008/0214055 A1
(43) Pub. Date: Sep. 4, 2008

(54) ELECTRICAL CONNECTOR ASSEMBLY

(76) Inventor: JOSEPH M. GULLA, NASHUA, NH (US)

Correspondence Address: WOLF GREENFIELD & SACKS, P.C., 600 ATLANTIC AVENUE, BOSTON, MA, 02210-2206, US

(21) Appl. No.: 11/961,341

(22) Filed: Dec. 20, 2007

Related U.S. Application Data
(60) Provisional application No. 60/875,807, filed on Dec. 20, 2006.

(51) Int. Cl. H01R 25/00

(52) U.S. Cl. 439/638

(57) ABSTRACT

A ruggedized, two-piece electrical connector. One piece, which may be configured for mounting to a daughtercard, is assembled from wafers. Each wafer includes a shield member and signal contacts held by an insulative member. Within the insulative member, the signal and ground contacts run in spaced, parallel planes. Both signal and ground contacts terminate in pads along a mating segment of the connector. The second piece of the connector, which may be configured for mounting to a backplane, has a housing with slots to receive the mating segments of the wafers. Within the slots, the backplane connectors have contacts that provide at least four points of contact with each pad. The contact points are at least two different heights on each side of the pad.

### BACKGROUND OF INVENTION

1. Field of Invention

The present invention relates generally to electronic assemblies and more specifically to electrical connectors for interconnecting circuit boards.

2. Discussion of Related Art

Electrical connectors are used in many electronic systems. It is generally easier and more cost effective to manufacture a system on several printed circuit boards (“PCBs”) that are connected to one another by electrical connectors than to manufacture a system as a single assembly. A traditional arrangement for interconnecting several PCBs is to have one PCB serve as a backplane. Other PCBs, which are called daughter boards or daughter cards, are then connected through the backplane by electrical connectors.

Additionally, electrical connectors are used to make connections between other components of electronic assemblies. For example, electrical connectors may be used to connect daughter cards containing circuitry to motherboards, to connect extension boards to printed circuit boards, to connect cables to printed circuit boards or to connect chips to printed circuit boards.

Conventional circuit board electrical connectors are disclosed in the U.S. Pat. Nos. 6,824,391 to Mickievicz et al., 6,811,440 to Rothermel et al., 6,655,966 to Rothermel et al., 6,267,604 to Mickievicz et al., and 6,171,115 to Mickievicz et al., the subject matter of each of which is incorporated by reference.

Other examples of electrical connectors are shown in U.S. Pat. No. 6,293,827, U.S. Pat. No. 6,503,103 and U.S. Pat. No. 6,776,659, all of which are hereby incorporated by reference in their entireties.

### SUMMARY OF INVENTION

In one aspect, the invention relates to a first connector having a mating segment. Conductive elements within the first connector terminate in pads on two surfaces of the mating segment. A second connector includes mating conductive elements that mate with the pads. The mating conductive elements include multiple contact surfaces, providing multiple points of contacts on each of the pads.

In a further aspect, the invention relates to a wafer for an electrical connector that includes first and second shielding members defining first and second grounding planes, and at least one signal contact disposed between the first and second shielding members. The signal contact has a first end terminal adapted for connection with a printed circuit board, and a second end terminal adapted for engaging a mating connector. The shielding members may be held together by a dielectric housing that substantially encapsulates the first and second shielding members.

In another aspect, the invention relates to an electronic assembly in which a guidance member in incorporated into a connector. By incorporating the guidance member in the connector, the use of a separate alignment pin may be avoided, freeing board space for fluid connections or other components.

In yet a further aspect, the invention relates to an electronic assembly including two connectors that mate. One connector is formed of wafers having mating segments and the other connector is formed with slots that receive the mating segments. The mating segments are adapted and arranged to allow float of the first connector relative to the second connector.

In yet a further aspect, the invention relates to an electrical connector assembled from wafers formed as printed circuit boards. Shock absorbing members are positioned between the printed circuit boards. Such a configuration may provide a more rugged connector.

In yet a further aspect, the invention relates to a contact for an electrical connector that facilitates a mating sequence with initially low insertion force, but that can generate sufficient retention force for a reliable electrical connection.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1a-1c illustrate one exemplary embodiment of a connector assembly in accordance with the present invention;

FIG. 1d illustrates a wafer that may be used in a connector assembly according to an embodiment of the invention;

FIG. 1e illustrates a wafer that may be used in a connector assembly according to an embodiment of the invention;

FIGS. 1f and 1g illustrate mating of conductive elements in a wafer and a backplane connector according to an embodiment of the invention;

FIG. 1h illustrates a wafer according to an alternative embodiment of the invention;

FIGs. 1i and 1j illustrate construction of a wafer according to an alternative embodiment of the invention;

FIGS. 2a-2d illustrate another exemplary embodiment of a connector assembly in accordance with the present invention;

FIG. 2e illustrates a wafer that may be used in a connector assembly of FIGS. 2a-2d;

FIG. 2f is a sketch of a wafer that may be used in a connector assembly of connectors 2a-2d according to an alternative embodiment of the invention;

FIGS. 2g and 2h illustrate construction of a wafer that may be used in connector assembly of FIGS. 2a-2d according to an alternative embodiment of the invention;

FIGS. 2i and 2j illustrate mating of a wafer to a backplane connector in the connector assembly of FIGS. 2a-2d;

FIG. 2k is a sketch of an alignment module according to an embodiment of the invention;

FIG. 2l is a sketch of a backplane connector that may be used with a wafer assembly including the guidance module of FIG. 2k;

FIG. 3 is a sketch of an electronic assembly that may employ connectors according to an embodiment of the invention;

FIGS. 4a and 4b are sketches of a connector assembly with an alignment module according to an alternative embodiment of the invention;

FIG. 5 is a sketch of a conductive element according to an embodiment of the invention;

FIG. 6a illustrates a wafer according to an embodiment of the invention;

FIG. 6b illustrates conductive elements within the wafer of FIG. 6a;

FIG. 6c is a cross-section of the wafer of FIG. 6a through the line c-c;

FIG. 6d is a sketch illustrating points of contact on one side of a conductive element of the wafer of FIG. 6a;

FIG. 6e is a cross-section through the wafer of FIG. 6a taken along the line e-e;

FIG. 6f is a cross-section of a wafer according to an alternative embodiment of the invention;

FIG. 7 is a sketch of a backplane housing according to an embodiment of the invention;

FIG. 8 is a sketch of an alternative embodiment of a connector assembly with shock absorbing members positioned between subassemblies;

FIG. 9 is a sketch of a backplane connector, partially cut away, according to an embodiment of the invention;

FIG. 10A is a sketch of a contact of the backplane connector of FIG. 9;

FIG. 10B is a cross sectional view of a portion of the backplane connector of FIG. 9;

FIG. 11A is a cross sectional view of a portion of the contact of FIG. 10B during a first portion of a mating sequence;

FIG. 11B is a cross sectional view of the portion of the contact of FIG. 11A during a later stage of the mating sequence; FIG. 11C is a graph showing insertion force of the connector of FIGS. 11A and 11B during a mating sequence; and

FIG. 12 is a sketch of a contact that may be used in the backplane connector of FIG. 9 according to an alternative embodiment of the invention.

### DETAILED DESCRIPTION

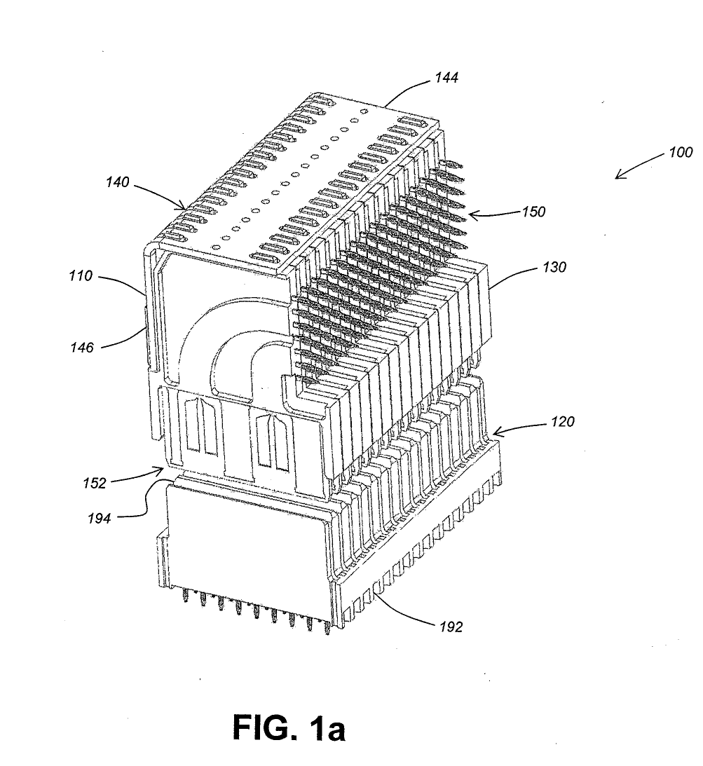

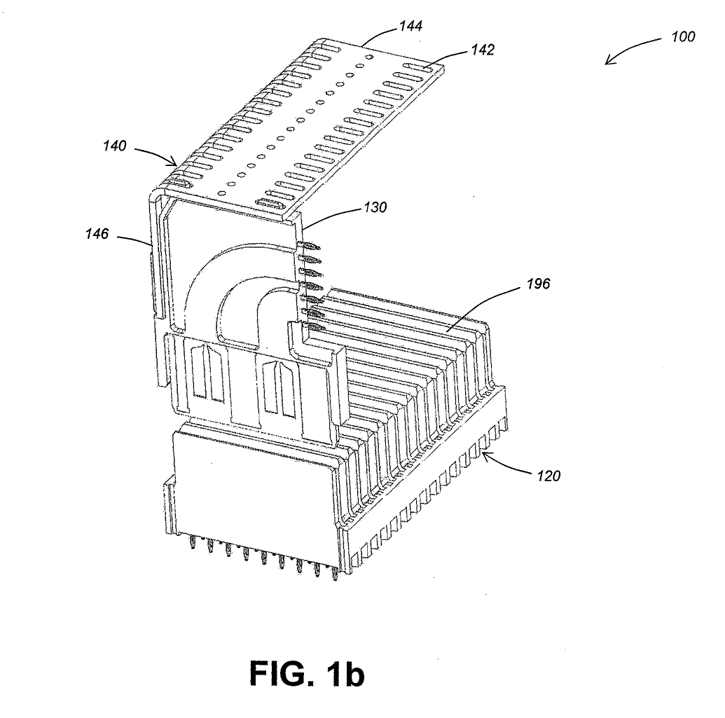

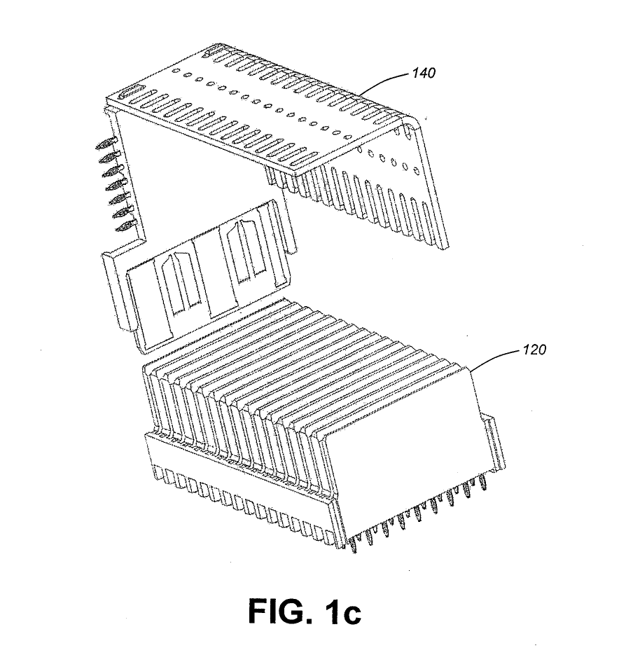

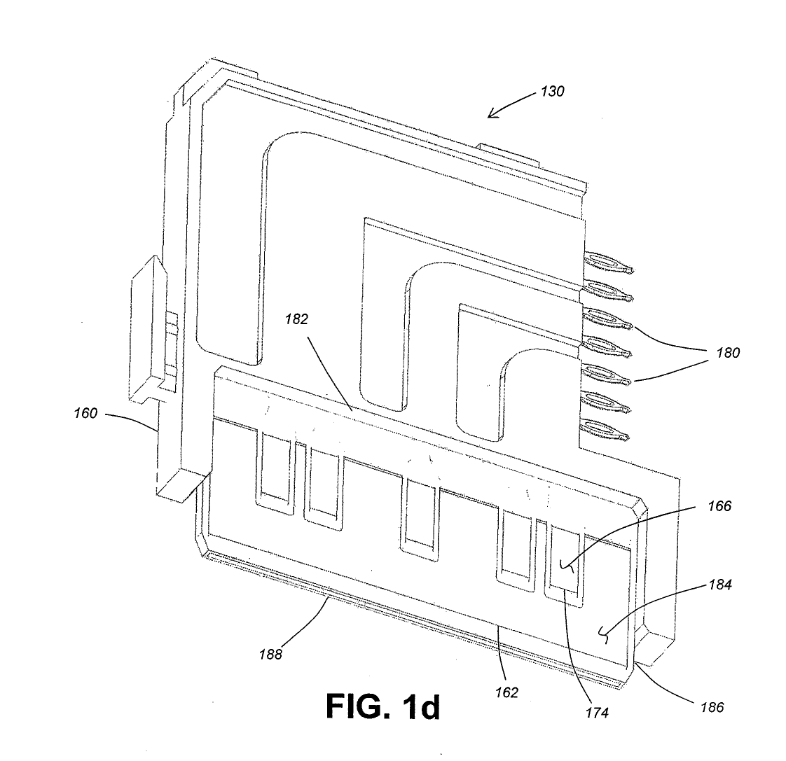

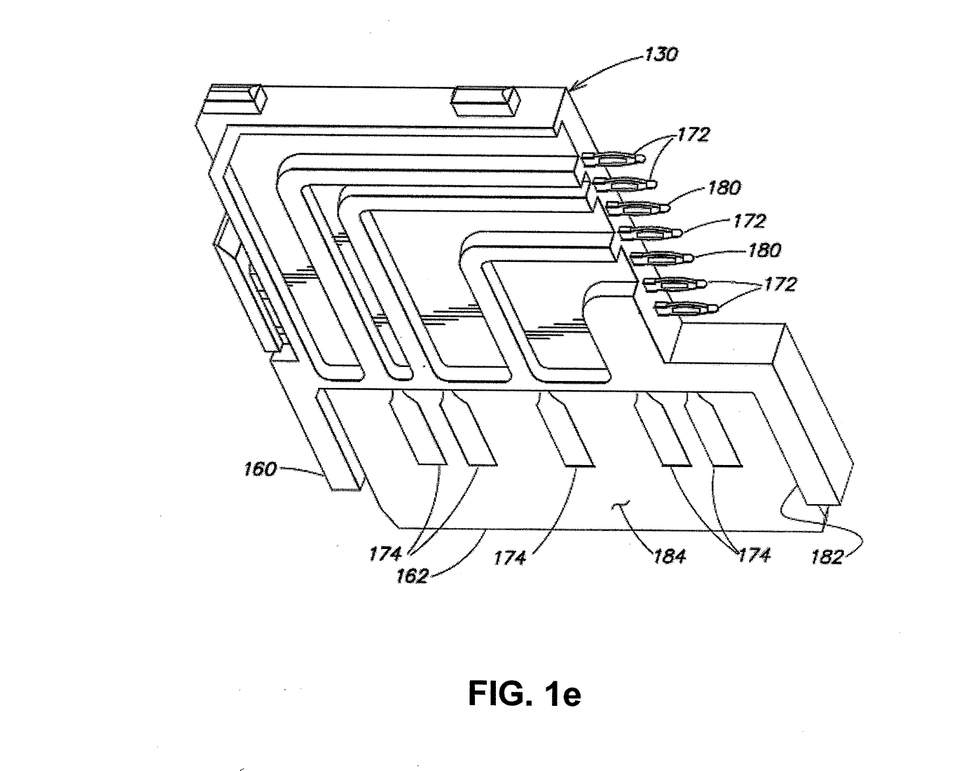

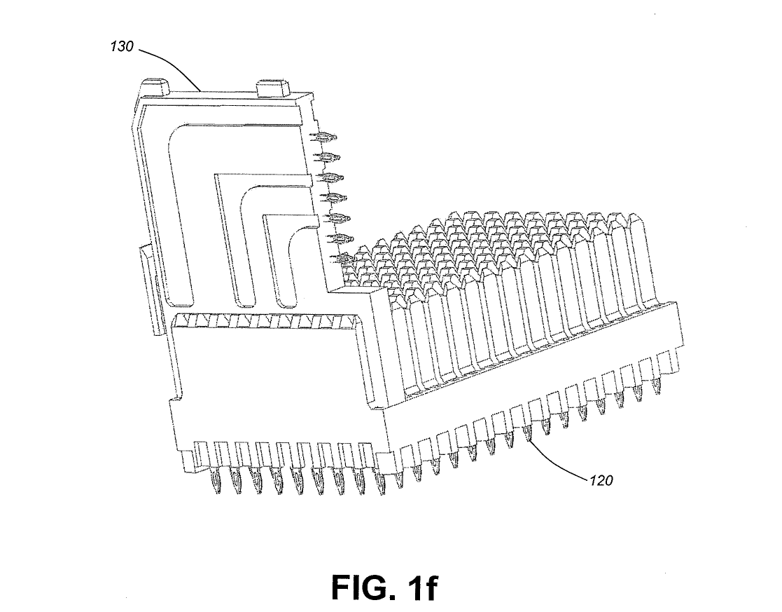

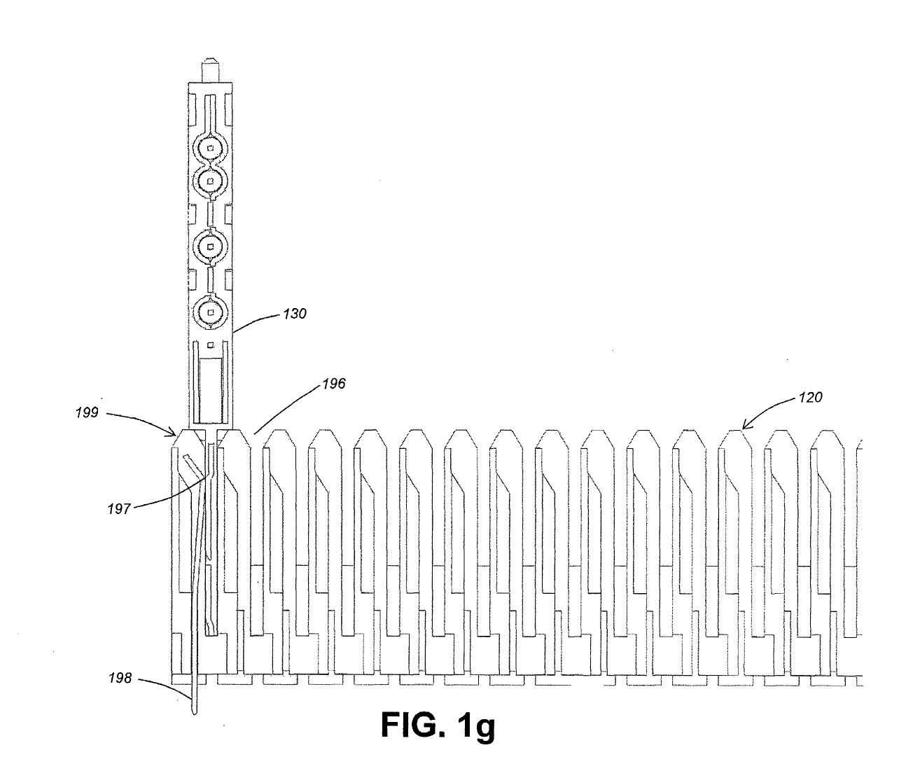

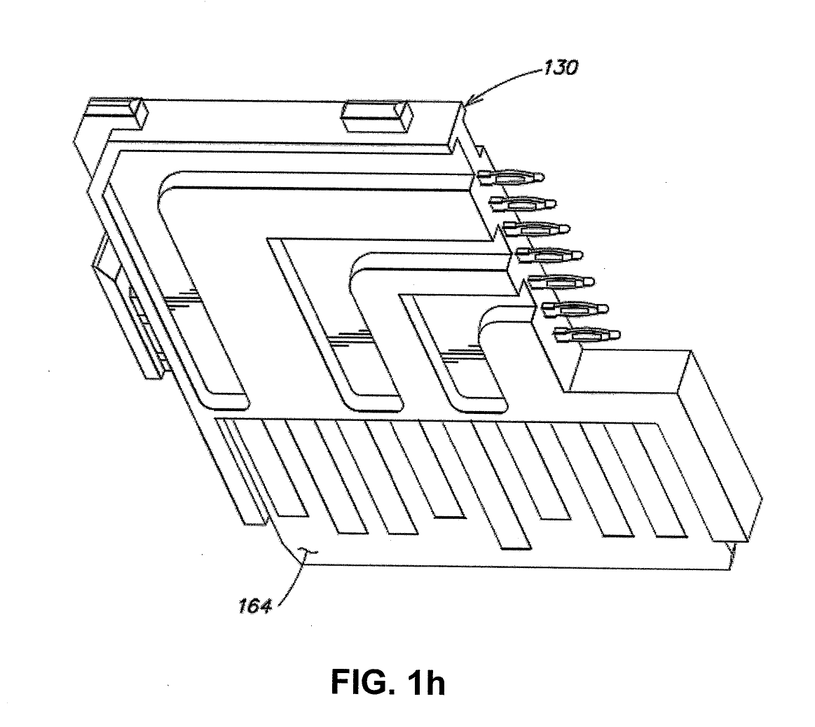

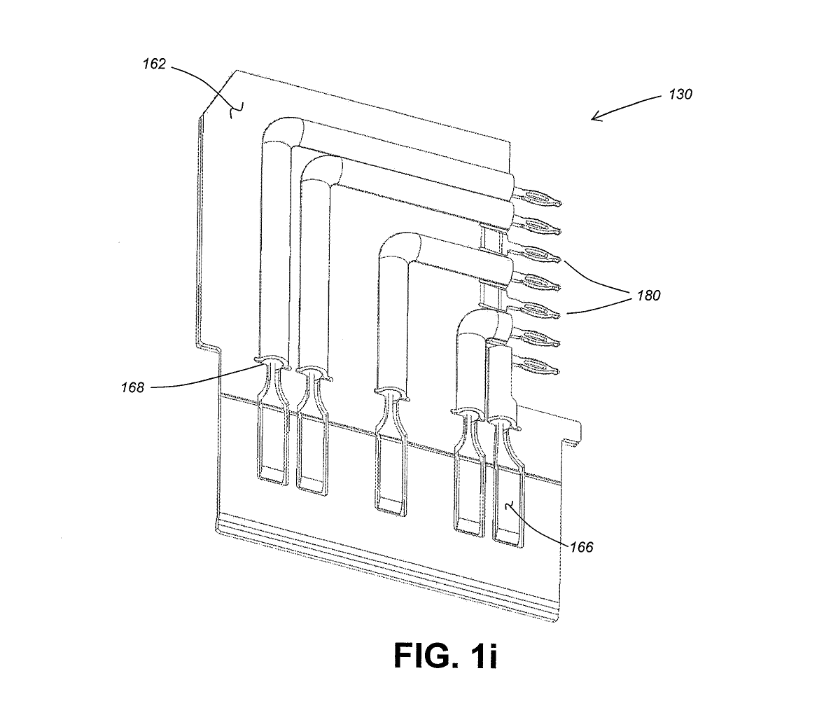

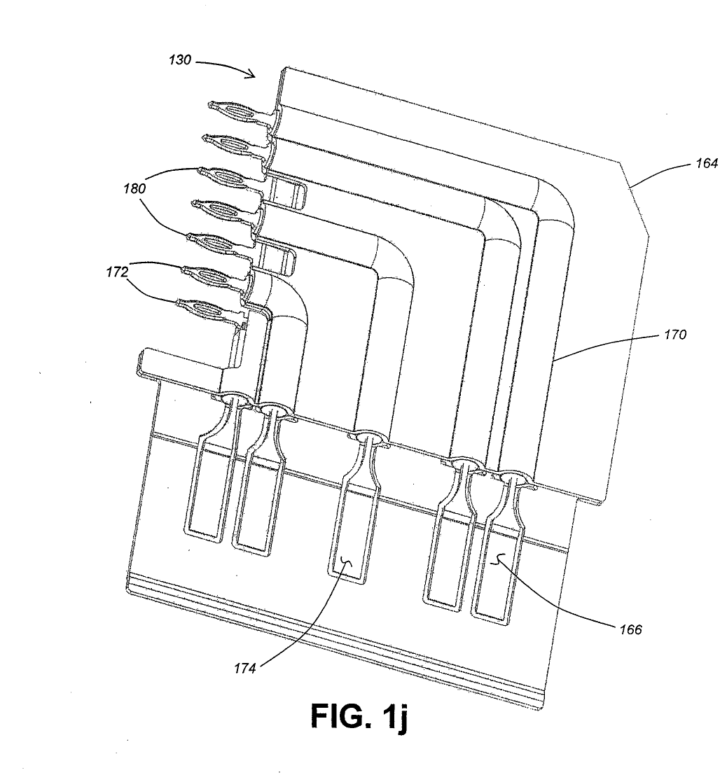

FIGS. 1a-1c disclose a connector assembly 100 that may be constructed using embodiments of the invention. In the embodiment illustrated, connector assembly 100 is configured as a right angle connector for mating a backplane and a daughterboard. However, the invention is not limited by the intended application and embodiments may be constructed for use as stacking connectors, mezzanine connectors, cable connectors, chip sockets or in any other suitable form. In the pictured embodiment, the connector assembly 100 includes a wafer assembly 110 that may be attached to a daughter board and a backplane connector 120 that may be attached to a backplane.

In the embodiment illustrated, wafer assembly 110 includes a plurality of individual wafers 130 supported by an organizer 140. The organizer 140 may be formed of any suitable material, including metal, a dielectric material or metal coated with a dielectric material. Organizer 140 includes a plurality of openings 142 corresponding to each wafer 130. The organizer 140 supports the wafers in a side-by-side configuration such that they are spaced substantially parallel to one another and form an array. The organizer 140 may include dielectric portions (not shown) that extend in the spaces between the wafers 130.

The array of wafers 130 define a board interface 150 for engaging the daughterboard (not shown), and a mating interface 152 for engaging the backplane connector 120 (FIG. 1a). The organizer 140 preferably includes first and second sections 144 and 146 forming an L-shape. However the organizer 140 may include only one of the first and second sections 144 and 146 or may have any other shape suitable for holding wafers in a desired position. In the embodiment illustrated, organizer 140 is constructed as a single member, but in some embodiments, two or more members may cooperate to form an organizer. In some embodiments, organizer 140 may be omitted and any suitable mechanism may be used to hold the wafers in an assembly.

The wafers 130 may contain projections or other attachment features that engage the organizer 140 via openings 142 (FIG. 1b) by any suitable attachment mechanism, including a snap engagement an interference fit or keyed segments. The openings 142 may be disposed in either or both of the first and second sections 144 and 146 of the organizer. Moreover, it is not crucial to the invention that organizer 140 include openings to receive features from wafers 130 because any suitable attachment mechanism may be used, including having projections from organizer 140 engage wafers 130.

FIG. 1d shows a wafer 130 according to an embodiment of the invention that may be used in a wafer assembly 110. Each wafer 130 (FIG. 1d) includes a housing 160 supporting one or more conductive elements. The conductive elements may be shaped and positioned to conduct signals and reference potentials. In the embodiment illustrated, signal conductors and reference conductors have different shapes. The signal conductors may be positioned to carry differential signals and/or single-ended signals. In the embodiment of FIG. 1d, wafer 130 is configured to carry two differential signals and one single-ended signal.

Each signal conductor may have a contact tail designed to be attached to a printed circuit board. In the embodiment of FIG. 1d, the contact tails are in the form of press-fit contacts forming terminals 172. However, any suitable contact tail may be used, including posts, surface mount J-leads, through-hole leads or BGA pads. Terminals 172 may have compliant segments that may be compressed to fit in a conductive via in a printed circuit board or other substrate. Once inserted in the via, the compliant member exerts an outward force to make electrical contact to the via and to provide mechanical attachment of wafer 130 to the board. In some embodiments, the mechanical attachment provided by terminals of wafer 130 may adequately secure wafer 130. In other embodiments, additional mechanical attachment structures may be used.

Each signal conductor also has a mating contact portion, adapted to make connection to a conductive element within blackplane connector 120. In the embodiment of FIG. 1d, each mating contact portion is shaped as a conductive pad, illustrated as a terminal 174. In this embodiment, terminals 174 provide pads against which one or more compliant segments from a mating contact may press to make electrical connection between wafer assembly 110 and a backplane connector 120. However, wafer 130 may have any suitable form of mating contact portion.

Each signal conductor also includes an intermediate portion, joining the first terminal 172 to the second terminal 174. The intermediate portion forms a signal track 166 through the wafer. In this way, signals may be transmitted from a circuit card, through the wafer 130 to a backplane connector 120, which in turn may be connected to conductive traces in a backplane (not shown).

Each wafer 130 may also include one or more reference potential conductors. In the embodiment of FIG. 1d, each wafer includes a single reference potential conductor that has a generally planar shape. In the embodiment illustrated, the reference potential conductor includes contact tails and mating contact portions. The contact tails may also be in the form of press fit contacts forming ground terminals 180. However, any suitable mechanism may be used to attach the reference potential conductors to a printed circuit board or other substrate. In the embodiment illustrated, the mating contact portions of the reference potential conductors are also in the form of pads against which a beam or other compliant member from a mating contact in backplane connector 120 may press to form an electrical connection. In the embodiment illustrated, the mating contact portions are formed by exposed surface areas 184 of the reference potential conductor.

In the embodiment of FIGS. 1a-1g, each wafer assembly includes a generally planar reference potential conductor that runs parallel to the signal conductors. In this configuration, the reference potential conductor may act as a shield 162 that reduces cross-talk between signal conductors in adjacent wafers 130 of wafer assembly 110. Additionally, configuring a signal track parallel to such a shield member may form a micro strip transmission line, having desirable electrical properties, including a controlled impedance and few discontinuities that could create signal reflections.

To provide a desirable spacing between signal tracks and a corresponding shield, the signal conductors and reference potential conductors may be held within a housing 160. Wafer 130, for example, may be formed by insert molding conductive elements in housing 160. In such an embodiment, housing 160 may be an insulative material, such as a plastic or nylon. However, any suitable material may be used to form housing 160.

Each shield 162 includes ground terminals 180 separate from the signal tracks 166 and formed integrally with the shields, such that the shields and ground terminals 180 form a unitary, one-piece member. The ground terminals 180 extend from each shield at board interface 150 for engagement with the daughterboard, such as by a press-fit. Because the ground terminals 180 are formed integrally with shield 162, a separate connection is not required between the ground terminals 180 and the shields, which may reduce manufacturing costs and provide a more robust connector.

Each wafer housing 160 may substantially encapsulate shield 162. Though, in some embodiments, only a portion of shield 162 may be embedded in housing 160. In yet further embodiments, other mechanisms may be used to hold a shield in a wafer, such as by snapping or otherwise attaching shield 162 to housing 160.

In the embodiment illustrated, each housing 160 includes a cutout portion 182 that forms a mating segment. Cutout portion 182 exposes the second end terminals or pads 174 of the signal tracks 166 for connection with the backplane connector 120. Surface areas 184 (FIG. 1d) of the shield around the pads 174 are also exposed and provide a ground connection.

Shield 162 may extend to edge 186 of the housing 160 to form a ground plane extension 188. When the wafers 130 are held in a wafer organizer 140 to create a wafer assembly 110, ground plane extensions 188 of the individual wafers will be exposed at mating interface 152. If any object that has a static charge on it comes into contact with mating interface 152, that static charge will be conducted through the ground plane extensions 188, through shields 162, through terminals 180 into the ground system of a printed circuit board to which wafer assembly 110 is attached. Because terminals 174, which may be connected to signal generating devices on a daughter board, are not exposed at mating interface 152, the possibility that static electricity will be discharged through the signal conductors is significantly reduced. Avoiding discharge of static electricity through the signal conductors may be desirable because static electricity discharged through a signal conductor may create a damaging voltage on an electronic component on a daughtercard to which wafer assembly 110 is attached.

FIGS. 1f and 1g illustrate mating of conductive elements within a wafer assembly 110 to conductive elements within a backplane connector 120. The backplane connector 120 includes a housing 192 with a mating interface 194 for engaging the mating interface 152 of the array of wafers 130 (FIG. 1a). The housing 192 includes an array of slots 196 for receiving corresponding individual wafers 130. In the embodiment illustrated, each slot 196 receives a cutout portion 182 of a corresponding wafer 130.

A plurality of conductive elements may be positioned along each slot 196. Each conductive element may have a mating contact portion, adapted to mate with a conductive element within wafer assembly 110 when wafer assembly 110 is mated with backplane connector 120. In the embodiment illustrated, the conductive elements of backplane connector 120 include signal conductors positioned and shaped to mate with the signal conductors in wafer assembly 110 and ground conductors positioned and shaped to mate with the ground conductors in wafer assembly 110.

In the embodiment illustrated, each conductive element in backplane connector 120 has a contact tail extending from housing 192 for attachment to a printed circuit board or other substrate, such as a backplane. The conductive elements in backplane 120 may be in any suitable form. In the embodiment illustrated, the signal conductors and the ground conductors have different shapes. The signal conductors are in the form of elongated beams, with each signal conductor having multiple beams to provide multiple points of contact with a terminal 174. The ground conductors are in the form of opposing compliant segments that form a slot adapted to receive an exposed portion of a shield 162. However, any suitable size or shape of mating contact portion may be used.

In the embodiment illustrated in FIG. 1g, a signal contact 198 within backplane connector 120 is illustrated with a hook-shaped end 199. Hook-shaped end 199 is adapted to be retained within housing 192, while allowing contact surface 197 to extend into a slot 196 to make contact with a mating contact portion of a conductor from a wafer 130. This configuration may be desirable to reduce stubbing upon insertion of a wafer 130 into a slot 196.

FIG. 1h illustrates an alternative embodiment of a wafer 130. In the embodiment of FIG. 1h, wafer 130 has a different number of signal conductors than the embodiment illustrated in FIG. 1d. However, the number and positioning of signal conductors is not a limitation on the invention, and a wafer of any number of signal conductors may be constructed according to embodiments of the invention.

FIGS. 1i and 1j illustrate an alternative approach for constructing a wafer 130. In the embodiment illustrated, two shield members may be used. Each shield may be formed with one or more contact tails adapted to engage a printed circuit board. Each shield also may include a mating contact portion. The shields may be formed to include channels 168 into which signal tracks 166 may be placed. Signal tracks 166 may have the same shape as in the embodiment of FIG. 1d, including contact tails for engagement to a printed circuit board and a mating interface for mating to corresponding signal conductors in a backplane connector. As shown, each signal track 166 includes opposite first and second terminals 172 and 174 at its ends. The first terminal 172 of each signal track 166 may be a press-fit pin at the first mating interface 150, and the second terminal 174 may be a pad at the second mating interface 152.

When the wafer is assembled, signal tracks 166 are sandwiched between channels 168 formed in the shields 162 and 164 (FIGS. 1i and 1j). Surrounding each signal track is insulation 170 that may substantially fill the channels 168 of the shields 162 and 164. In the embodiment illustrated, the insulation is in the form of a plastic or other moldable material, though some or all of the insulation may be air or other suitable material.

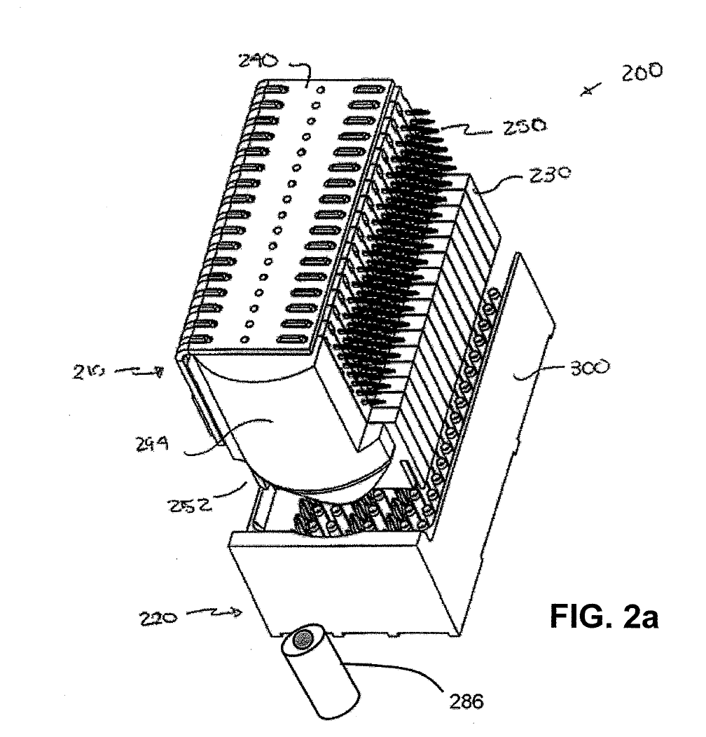

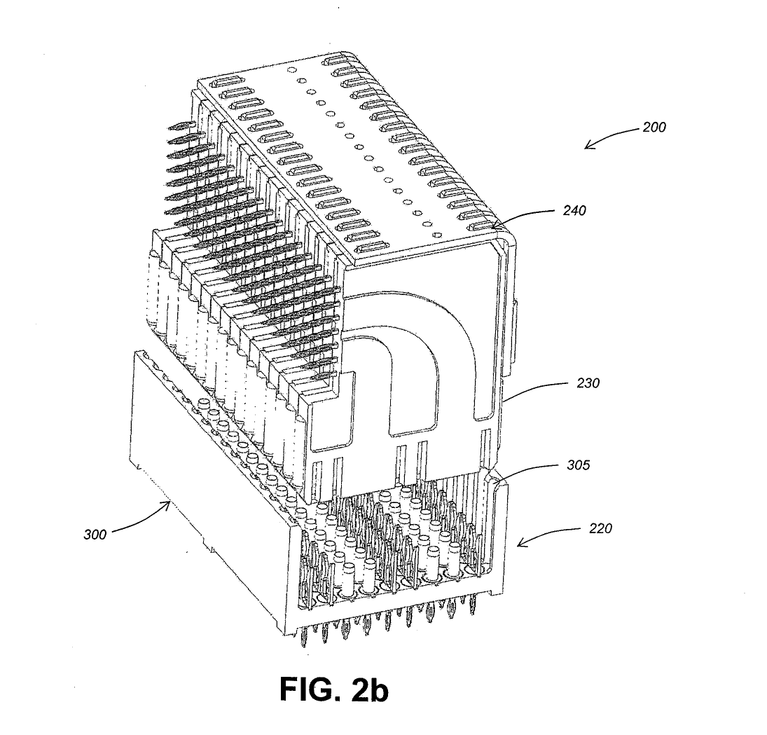

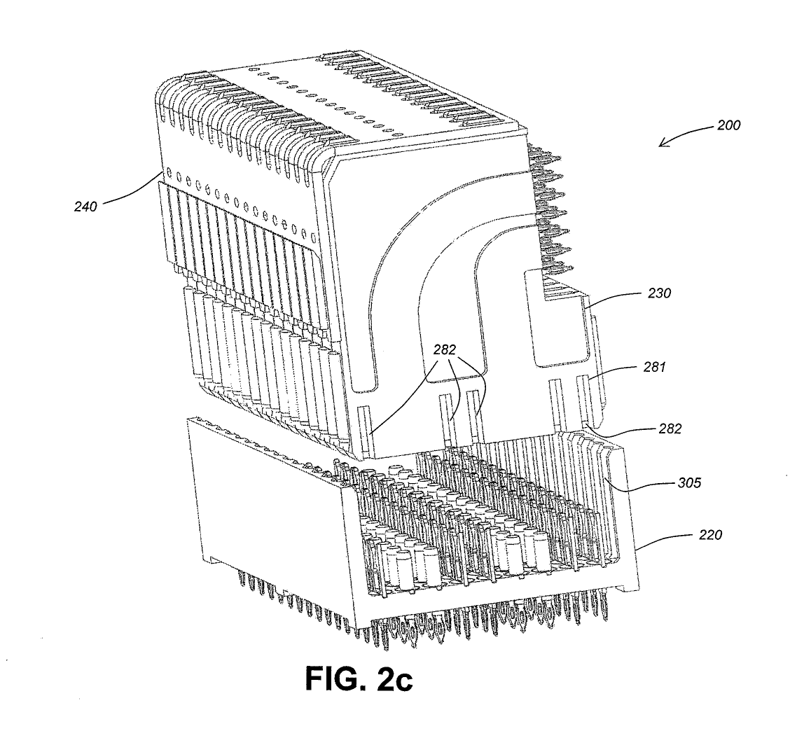

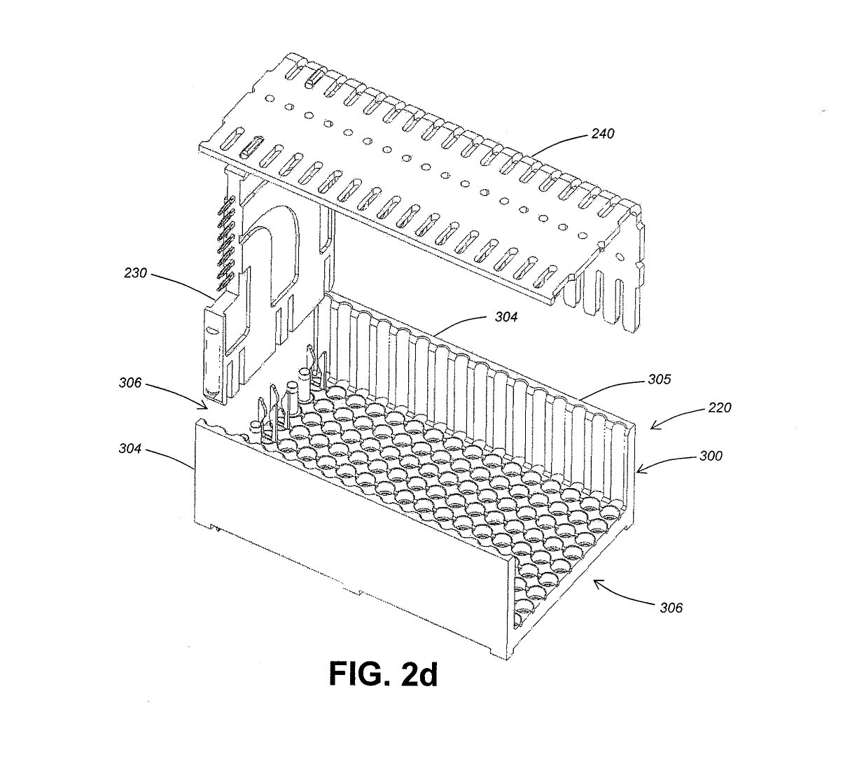

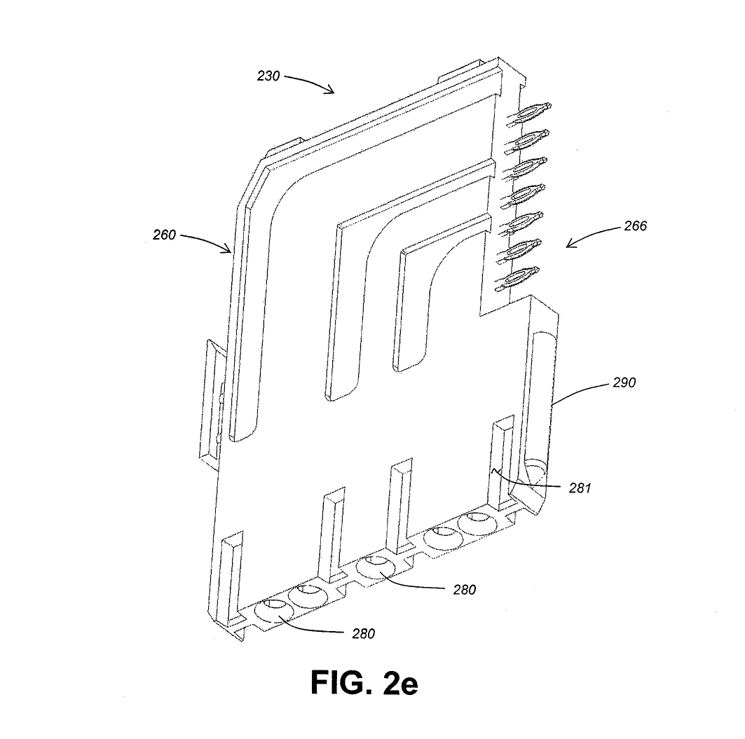

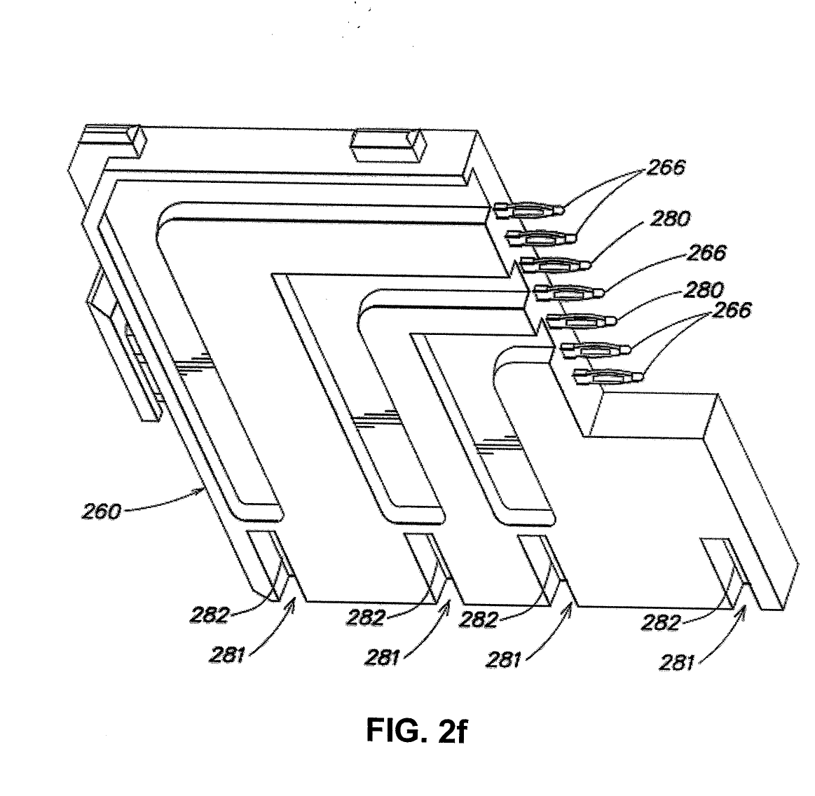

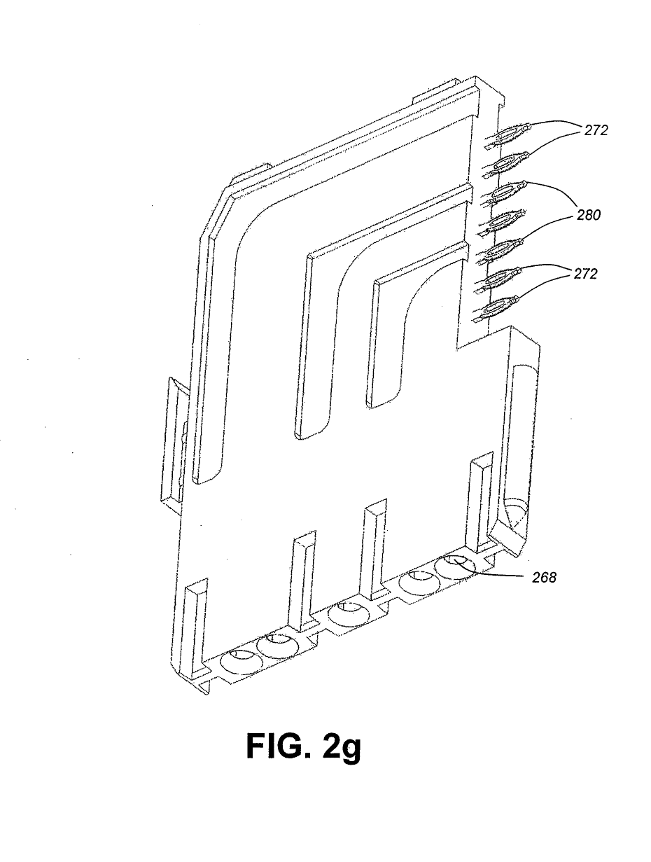

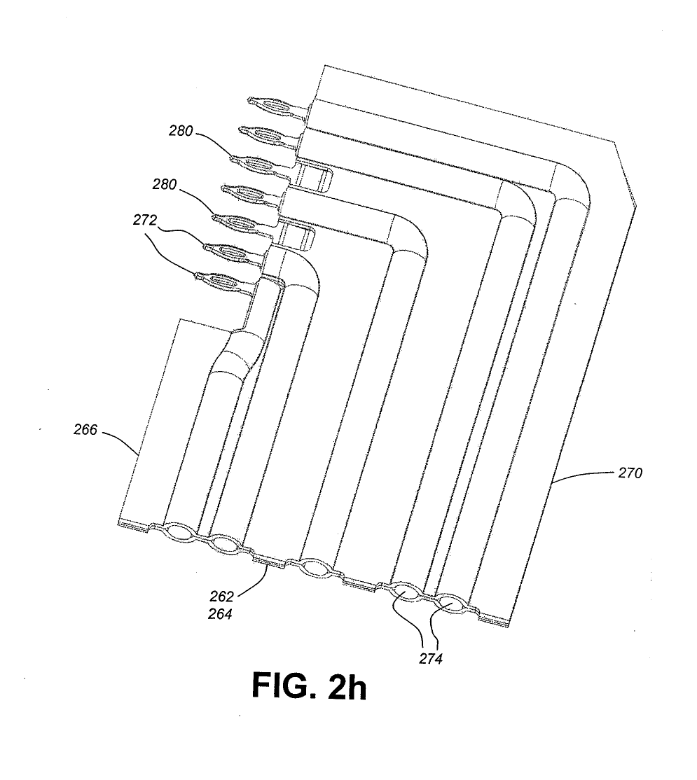

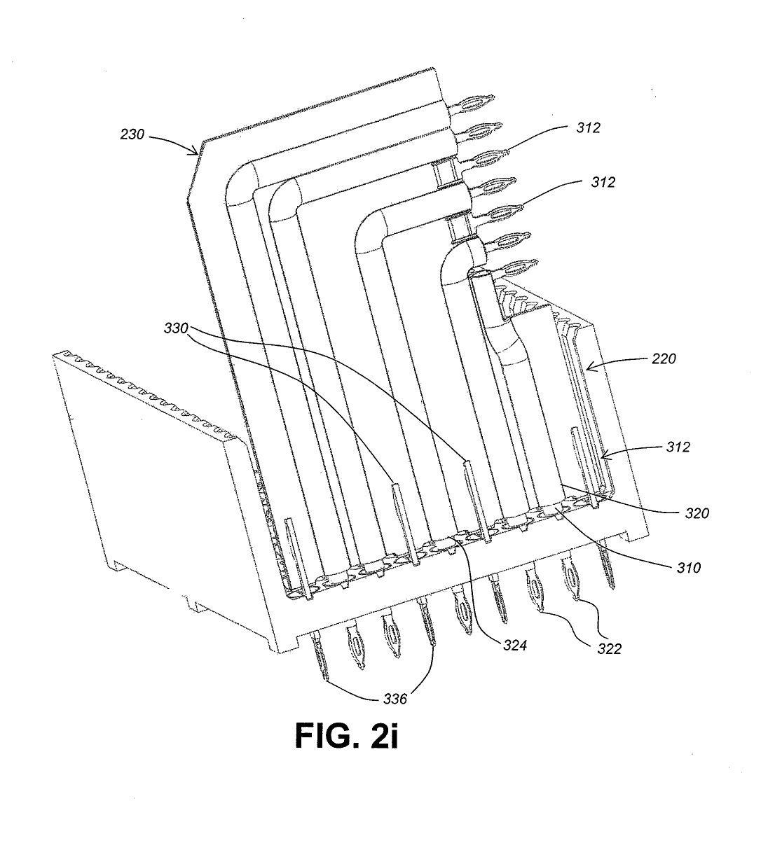

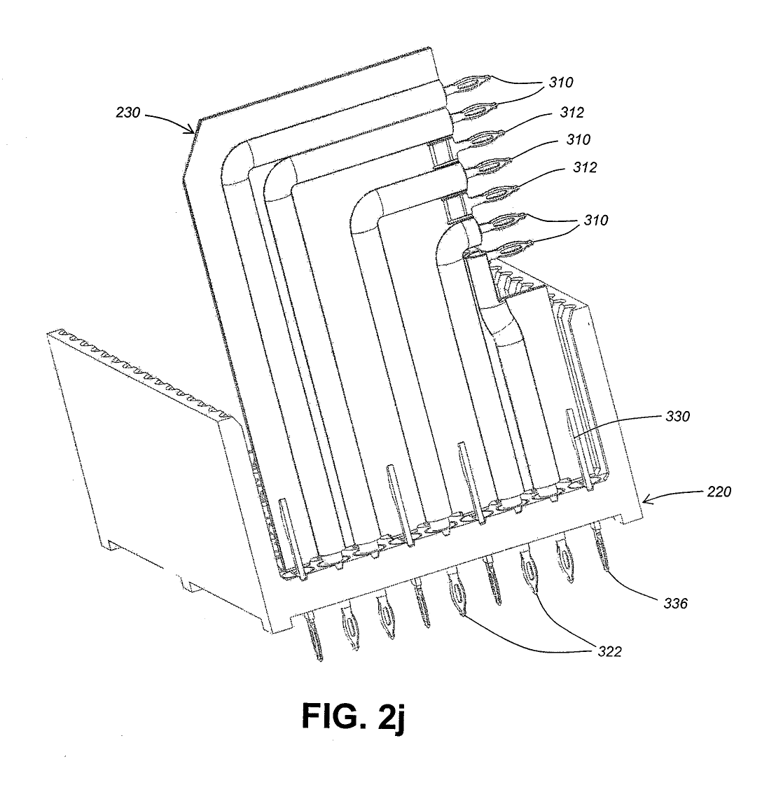

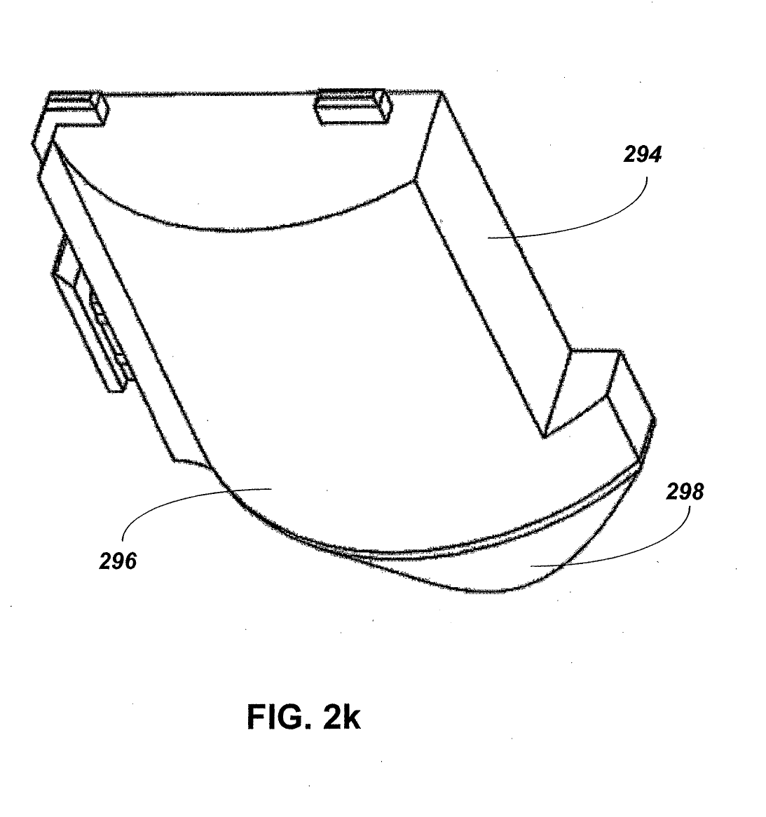

FIGS. 2a-2l illustrate a second exemplary embodiment of the present invention, including a connector assembly 200 with a wafer assembly 210 and a backplane connector 220. Similar to wafer assembly 110 of above described embodiments, wafer assembly 210 includes an array of wafers 230 and an organizer 240. Wafer assembly 210 has a board interface 250 and a second mating interface 252.

Each wafer 230 of the second embodiment includes a housing 260 supporting first and second conductive shields 262 and 264. Signal tracks 266 are sandwiched between channels 268 formed in the shields 262 and 264 (FIGS. 2g and 2h). Surrounding each signal track may be insulation 270, which may substantially fill the channels 268 of the shields 262 and 264. Molding or other suitable operation may be used to position insulation 270 after signal tracks 266 have been positioned in the recesses. Insulation 270 may be molded around signal tracks 260 before insertion into the channels or after insertion. However, the invention is not limited to embodiments in which insulation fills the channels, spacers or other suitable mechanisms may be used to electrically isolate tracks 266 from shields 262 or 264.

Each signal track 266 includes opposite first and second terminals 272 and 274 at its ends adapted to form a contact tail for attachment to a printed circuit board or other substrate and a mating contact portion for mating to a corresponding conductive element in a mating connector. The first terminal 272 of each signal track 266 may be a press fit pin at the first mating interface 250.

Unlike embodiments in which mating contact portions were illustrated as pads, wafer 230 is illustrated with signal conductors having mating contact portions that may be shaped as pins or other structures that fit within channels 268. However, terminals 274 may have any suitable shape. Complimentary mating contact portions may be included on signal conductors within backplane connector 220. To receive a mating contact portion in the shape of a pin from a wafer 230, the mating contact portion in backplane connector 220 may be in the form of a receptacle. The receptacle may be surrounded by insulating material to preclude electrical connection between the mating contact portion of a signal conductor in backplane connector 220 and a shield 262 or 264. However, any suitable contact configuration may be used for mating contact portions within backplane connector 220, including using a post within backplane connector 220 and a receptacle at an end of a signal track 266 within the wafer.

Each shield 262 and 264 includes ground terminals 280 separate from the signal tracks 266 and formed integrally with the shields, such that the shields and ground terminals 280 form a unitary, one-piece member (FIGS. 2g, 2h). The ground terminals 280 extend from each shield at the first mating interface 250 for engagement with the daughterboard, such as by press-fit.

A housing 260 may encapsulate the shields 262 and 264 and may include a plurality of vertical slots 281 (FIG. 2f) exposing select portions of the shield to provide ground contact areas 282. However, any suitable mechanism may be used to hold the shields 262 and 264 together. Housing 260 may be formed of any suitable material and, for example, may be a molded dielectric material, such as plastic or nylon. Though, in some embodiments, housing 260 may be conductive or partially conductive. An end of the housing 260 at the second mating interface 252 includes openings 284 corresponding to the ends of the signals 266, thereby defining receptacles for receiving corresponding mating contacts of the backplane connector 220. The housing 260 may also include a guide portion 290 (FIG. 2e) extending from the housing 260 to engage a corresponding slot of the backplane connector 220.

Another guidance feature may be added to the wafer assembly 210 for facilitating connection to the backplane connector 220. For example, a guide piece 294 may be coupled to the organizer 240 at the end of the array of wafers (FIGS. 2a and 2k). The guide piece 294 may include a main body 296 having a generally convex outer surface and end portion 298 that is tapered for reception in a corresponding portion of the backplane connector 220.

As best seen in FIGS. 2a-2d and 2l, the backplane connector 220 may include a U-shaped housing 300 with a main body 302, two longitudinal sidewalls 304, and two open ends 306. Slots 305 are provided on the inner surfaces of the sidewalls 304 for receiving the wafers 230. Slots 305 may be configured to receive the guide portions 290 of each wafer. A plurality of openings 308 (FIG. 2d) that receive contacts 310 and 312 designated for both signal and ground are located in the main body 302. The contacts 310 and 312 are arranged in rows between open ends 306 and may alternate between signal and ground. For example, five rows of signal contacts 310 may alternate with three rows of ground contacts 312 (FIG. 2j). The signal contacts 310 correspond to the signal tracks 266 of the wafers 230 and the ground contacts 312 correspond to the ground contact areas 282 of the wafers 230.

Each of the signal contacts 310 may include a first end 320, such as a receptacle that mates with the ends of the signal tracks 266 of each wafer 230 at the second mating interface 252. An insulator 324 may be provided around the first ends 320. The second ends 322 extending through the main body 302 may terminate in a press-fit pin for connection to the backplane. Because the first ends 320 of the signal contacts 310 are compliant, movement is allowed when the wafers 230 are mated with the backplane connector 260, thereby providing tolerance.

Each of the ground contacts 312 may include a first end 330 (FIG. 2h) with first and second spring arms for engaging the ground contact areas 282 of each wafer 230. The second opposite ends 334 extend through the main body 302 and terminate in press-fit section 336 for engagement with the backplane.

One of the open ends 306 of the housing may be closed off by a guide receiving wall 340 (FIG. 2l). The guide receiving wall 340 may include, for example, a concave recessed portion 342 on its inner surface for receiving the guide piece 292 of the wafer assembly.

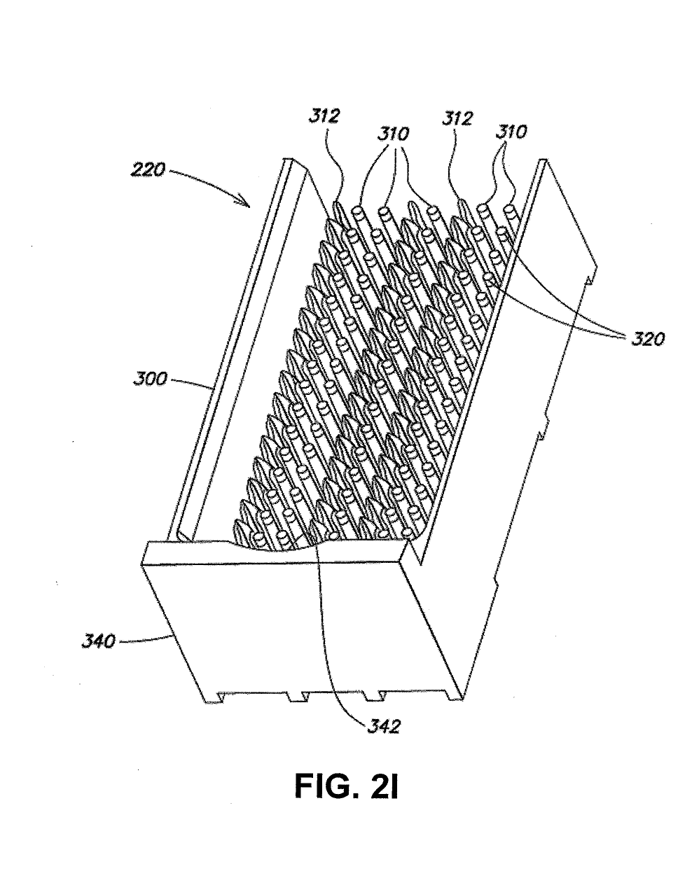

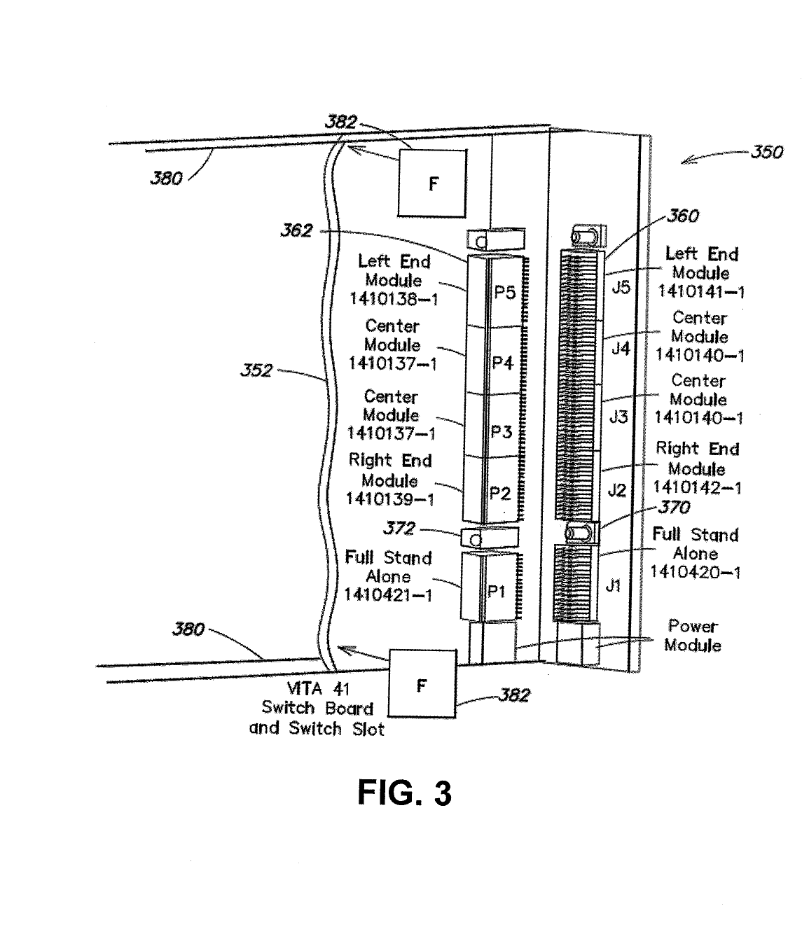

FIG. 3 illustrates an electronic assembly in which connectors according to embodiments of the invention may be used. FIG. 3 illustrates portions of an electronic assembly that includes a backplane 350. One or more daughtercards 352 may be mounted in the electronic assembly of FIG. 3. Backplane 350 may include one or more backplane connectors 360, which may be constructed according to an embodiment of the invention. Likewise, daughtercard 352 may include daughtercard connectors 362 according to an embodiment of the invention.

Daughtercard 352 may slide along rails 380 that provide a coarse alignment between daughtercard connector 362 and backplane connector 360. More precise alignment may be provided by alignment modules 370 on backplane 350 and corresponding alignment modules 372 on daughtercard 352. In this embodiment, alignment module 370 is in the shape of a post and alignment module 372 is in the shape of a receptacle that has a wide gathering area to ensure that alignment module 372 will engage the post of alignment module 370.

To provide a ruggidized assembly, rail locks 382 are sometimes used to secure daughtercard 352 within the electronic assembly. Rail locks 382 are illustrated schematically in FIG. 3. Rail locks operate by pressing daughtercard 352 against rails 380 and may be constructed with a camming surface or any other suitable mechanism to assert a force on daughtercard 352 to hold it securely in place. Rail locks 382 may be desirable for use in a ruggidized assembly because once engaged, they may limit vibration of daughter card 352. Vibration of daughter card 352 may cause excessive wear or fretting corrosion at the mating interface between daughter card connector 362 and backplane connector 360 or other performance problems. When rail locks 382 operate, daughtercard 352 may move relative to backplane 350. For this reason, it may be desirable to incorporate “float” into the connection system formed by backplane connector 360 and daughtercard connector 362. As described below, connectors according to some embodiments of the invention may be constructed with features that facilitate float so that rail locks may be used in an electronic assembly to provide a more ruggidized assembly.

FIG. 3 also illustrates how use of a connector using a guide piece such as a guide piece 294 may facilitate construction of electronic assemblies using fluid for cooling. FIG. 2a illustrates a backplane connector 220 designed to receive a daughtercard connector with a guide piece 294. Guide piece 294 may be used in place of alignment modules 370 and 372 (FIG. 3) to create additional space on backplane 350 for other components. Accordingly, FIG. 2a illustrates a fluid quick connect 286 mounted adjacent to backplane connector 220. Quick connect 286 is mounted in the same position occupied by alignment module 370. Quick connector 286 may be used to distribute cooling fluid to a daughtercard, such as daughtercard 352, when inserted into an electronic assembly.

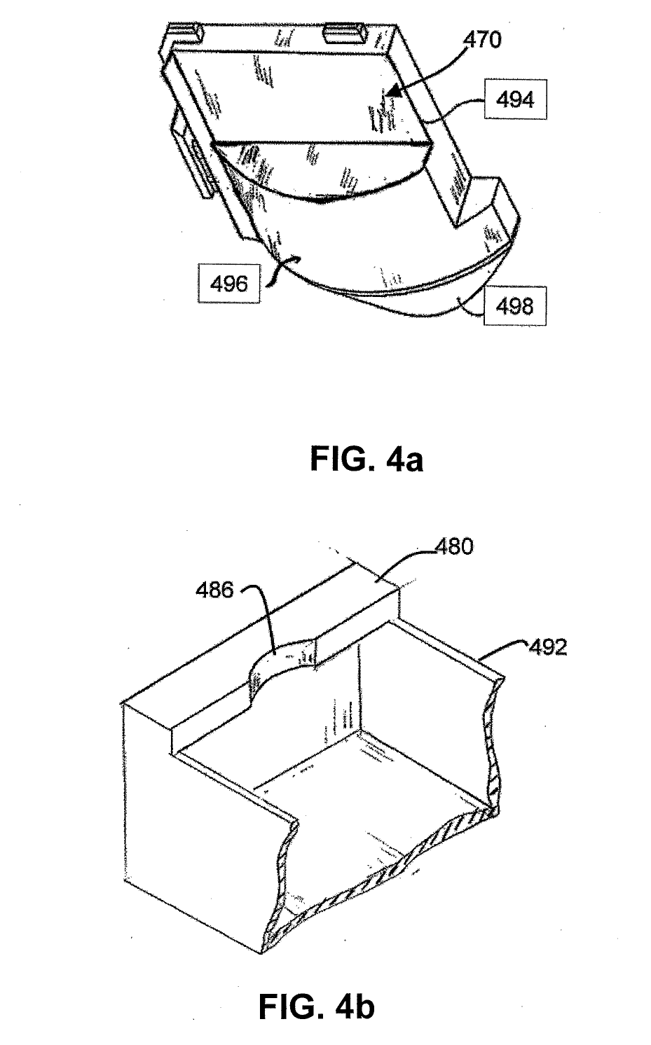

Turning to FIGS. 4a and 4b, an alternative embodiment of guide piece 294 is shown. In the embodiment illustrated, guide piece 494 is configured to allow float so the rail locks may be used. Guide piece 494 may be attached to a wafer organizer similarly to guide piece 294. As with guide piece 294, guide piece 494 includes a tapered portion 498 and a main body 496. Tapered portion 498 is adapted to engage a recess 496 (FIG. 4b) in a backplane housing 492. Tapered portion 498 performs a gathering function, ensuring that main body 496 aligns with recess 486 as guidepiece 494 is inserted into housing 492.

However, guidepiece 494 differs from guidepiece 294 in that guidepiece 494 includes a relieved portion 470. As a daughtercard connector including a guidepiece 494 mates with a backplane connector with a housing in the form of housing 492, the connectors are aligned by the action of tapered portion 498 and main body 496 engaging with recess 496. The alignment provided by the interaction of these components insures that the connectors are appropriately aligned to avoid stubbing as the daughtercard connector and backplane connector begin to mate. However, once the mating operation has proceeded to the point that the daughtercard connector is pressed into housing 492 sufficiently far that mating contacts from the daughter card connector have engaged corresponding contacts from the backplane connector, main body 496 will pass ledge 480. In this position, relieved portion 470 will align with ledge 480 and main body 496 no longer engages recess 486 to hold the daughtercard connector relative to housing 492. In this way, the daughtercard connector may float relative to backplane connector housing 492. Thus, guide piece 494 provides alignment during the beginning of the mating sequence when stubbing could occur. At the end of the mating sequence, guide piece 494 allows float so that a cam lock may be used to hold a daughtercard firmly in an electronic assembly.

In the embodiment illustrated, main body 496 has a curved surface similar to the curved surface 296 of guidepiece 294. This shape conforms to the shape of recess 486. It is not necessary that mainbody 496 have a curved surface. Main body 496 may have any suitable shape, with recess 486 having a shape complimentary to the shape of main body 496. For example, main body 496 may be rectangular, triangular or may contain multiple projections. In some embodiments, an electronic assembly using guidepieces as illustrated in FIGS. 4a and 4b may have guide pieces on different daughtercards having main bodies with different shapes. By providing daughter cards with connectors using alignment pieces of different shapes, each daughtercard will be able to engage only those backplane connectors having corresponding recesses with shapes complimentary to the shape of the main body used for that daughtercard connector. In this way, daughtercards may be precluded from being inserted into backplane connectors not designed to receive those daughtercards.

FIG. 5 illustrates conductive element 510 that may be used in a backplane connector according to an embodiment of the invention. In the embodiment illustrated, conductive element 510 is designed for use in a ruggedized system—both because it facilitates connector float so that rail locks may be used and because it provides reliable contact. Conductive element 510 includes four beams, 512a, 512b, 512c and 512d. Each of the beams has a contact surface, of which contact surfaces 514c and 514d are visible in FIG. 5. Conductive element 510 is designed to receive a mating contact portion so that beams 512a and 512b press on one side of the mating contact portion and beams 512c and 512d press on an opposing side of the mating contact portion.

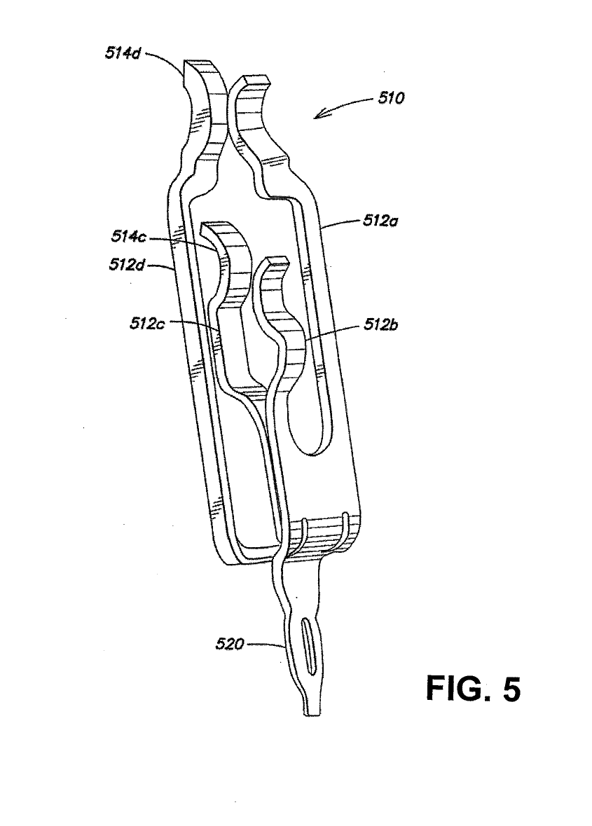

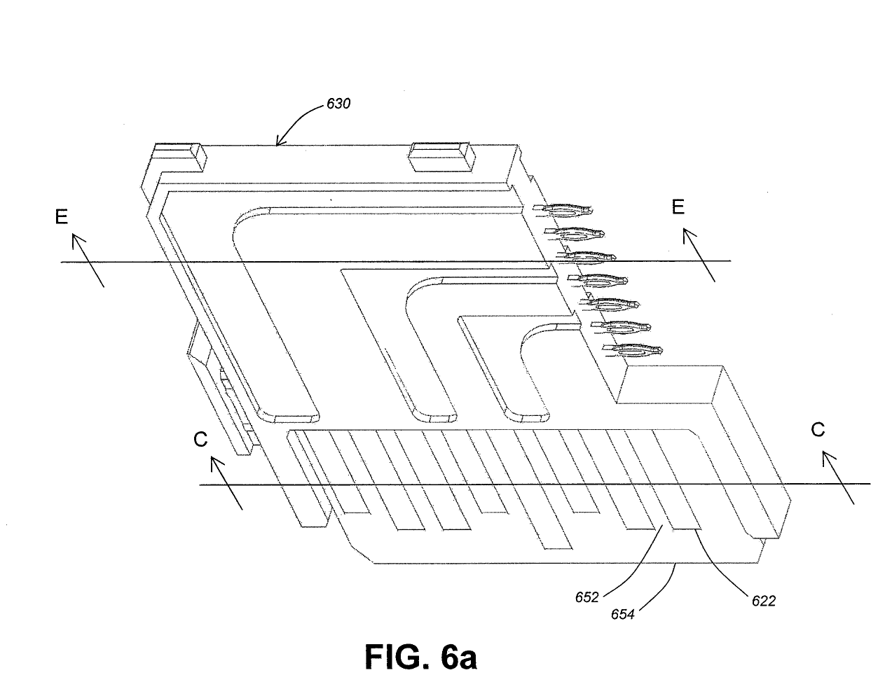

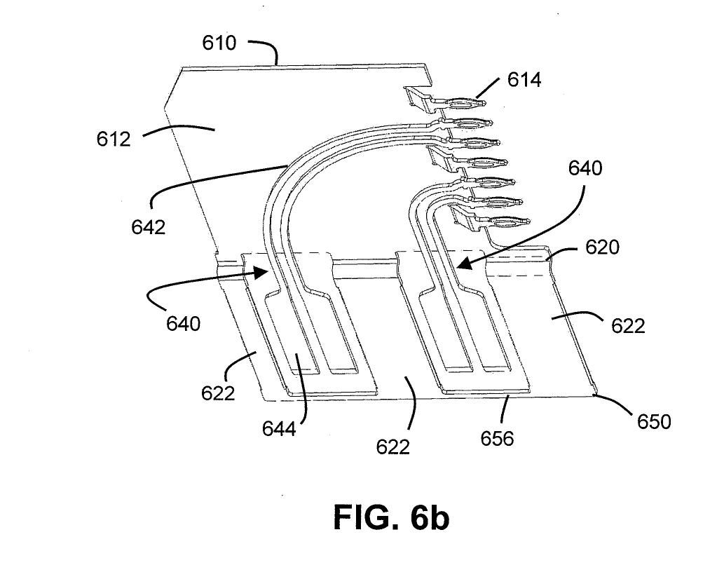

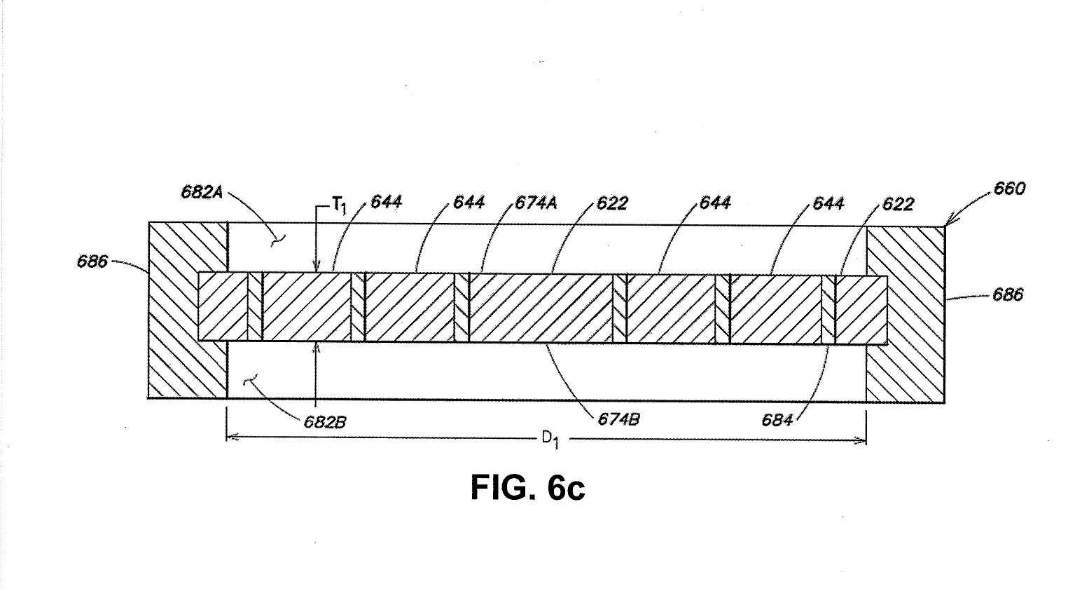

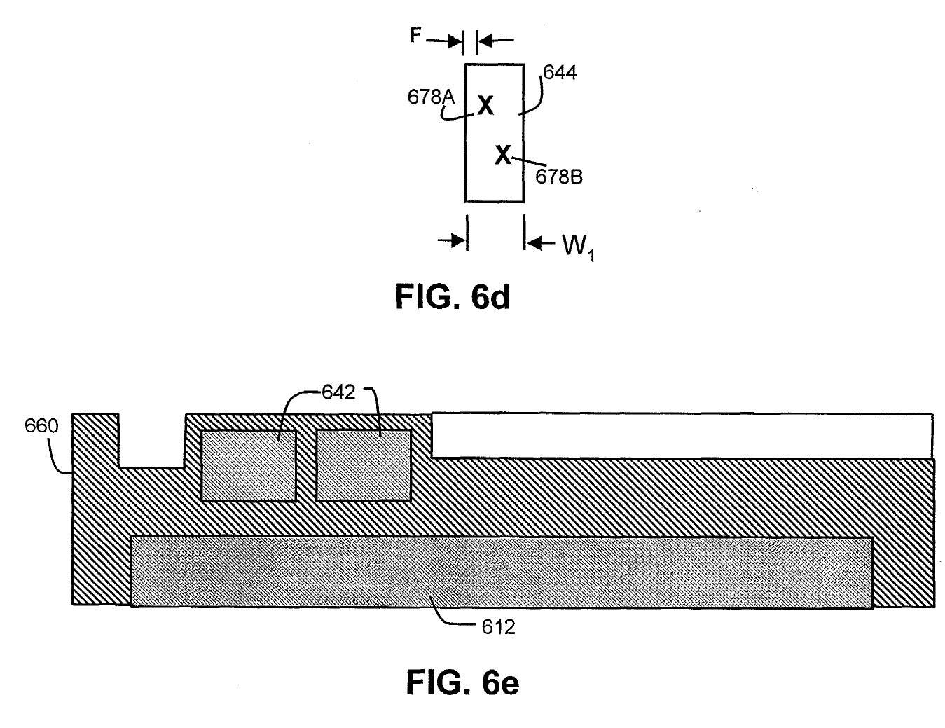

In this way, conductive element 510 provides four points of contact. Providing multiple points of contact increases the reliability of any electrical connection formed between conductive element 510 and a mating contact portion. Further, in the embodiment of FIG. 5, beams 512a, 512b, 512c and 512d are curved to bring the contact surfaces near the center of conductive element 510. By positioning the contact surfaces near the center, greater float is enabled. The additional float achieved with the contact configuration of FIG. 5 is illustrated below in connection with FIG. 6d.

Conductive element 510 may be formed in any suitable way. In the embodiment illustrated, conductive element 510 is stamped from a sheet of flexible metal. Conductive element 510 may be formed from a copper alloy, such as beryllium copper or phosphor bronze, or may be formed from any other suitably flexible and conductive material. Conductive element 510 may be formed in any suitable way. In the embodiment illustrated, the beams are stamped from a sheet of metal and then formed as illustrated. A contact tail 520 may be stamped from the same sheet of metal and integrally formed as a part of conductive element 510.

Turning to FIGS. 6a and 6b, additional details of a wafer 630 according to an embodiment of the invention are shown. FIG. 6a shows wafer 630 including an insulative housing. FIG. 6b shows the conductive elements of wafer 630 without the housing. As shown in FIG. 6b, shield 610 includes a planar portion 612. Contact tails, of which contact tail 614 is numbered, extend from planar portion 612.

Intermediate portion 642 of signal conductors 640 overlay planar portion 612. Intermediate portion 642 may be spaced from planar portion 612 by an amount that provides a desired impedance to signal conductors 640. In the embodiment illustrated, signal conductors 640 are arranged in differential pairs. In a differential configuration, the signal conductors may have an impedance of 100 Ohms or any other suitable value.

Each of the signal conductors terminates in a mating contact portion, here shown as pads 644. In the embodiment of FIG. 6b, the pads 644 are positioned in a plane, forming a column of signal contacts for wafer 630.

In the embodiment illustrated, the column of signal contacts also includes ground contacts. Those ground contacts are formed by pads 622 of shield 610. To align pads 622 in the same plane as pad 644, shield 610 includes a transition region 620 in which shield 610 is bent out of the plane containing planar portion 612 and into the plane containing pads 644. To avoid contact between shield 610 and signal conductors 640, shield 610 may include openings where shield 610 and signal conductors 640 are in the same plane.

As shown in FIG. 6b, pads 622 are separated from pads 644. This configuration avoids shorting signal conductors 640 to ground. When an insulative housing is molded around shield 610 and signal conductors 640, the space between pads 622 and 644 may be filled with insulative material of the housing. This insulative material forms regions 652 (FIG. 6a) and ensures that pads 644 do not touch pads 622. However, any suitable structure for isolating signal conductors 640 from shield 610 may be used.

As described above, it may be desirable for shield 610 to extend to the mating face of wafer 630 to avoid electrostatic discharge through signal conductors. Accordingly, the embodiment of FIG. 6b illustrates edge 650 of shield 610 extending beyond pads 622 and 644 to provide a shield extension 656.

In some embodiments, it may be undesirable to have edge 650 exposed on the surface of wafer 630 where mating contacts from a backplane connector engage pads 644. If shield extension 656 were exposed, a mating contact portion in a backplane connector sliding across the surface of wafer 630 to engage a signal pad 644 could be shorted to shield extension 656. Accordingly, edge 650 may be thinner than pads 644 and may be over-molded with insulative portion 654 (FIG. 6a). Insulative portion 654 prevents a mating contact sliding into engagement with pads 644 from contacting shield extension 656.

Shield 610 and signal conductors 640 may be formed in any suitable way. For example, they may be stamped from sheets of metal and formed into the desired shapes. In the embodiment illustrated, shield 610 and signal conductors 640 may be separately stamped and overlaid after stamping. Though in other embodiments, both shields and signal conductors may be stamped from the same sheet of metal. Shield extension 656 may be formed in any suitable way. For example, shield extension 656 may be formed to be thinner than pads 644 by coining edge 650 of shield 610.

FIG. 6c shows a wafer 630 in cross-section taken along line C-C through the mating segment of wafer 630. As shown, signal conductors and reference conductors are held within housing 660. Cut-out portions 682a and 682b on both sides of housing 660 expose terminal portions of the signal conductors and ground conductors, forming pads 644 on the signal conductors and pads 622 on the ground conductors.

In the embodiment illustrated, cut-out portions 682a and 862b expose the signal conductors and ground conductors on two surfaces, surfaces 674a and 674b. This configuration allows electrical connection to be made to each of the pads from both surface 674a and 674b. Making contact on two surfaces of a pad may be desirable because redundancy improves the reliability of the electrical connection formed to such a pad.

In some embodiments, the signal conductors and ground conductors are formed from a material having a thickness sufficient to provide a robust pad. For example, the material may have a thickness T₁ in excess of 8 mils. In some embodiments, the thickness may be between about 10 and 12 mils.

In some embodiments, a backplane connector may be formed to create multiple points of contact to each of the signal conducting pads and/or each of the reference conductor pads. For example, FIG. 6d illustrates one surface of a pad 644. Two points of contact, contact point 678a and 678b are illustrated. Two such points of contact may be formed using a conductive element in the form of conductive element 510 (FIG. 5). Two such points of contact may, for example, be formed by beams 512a and 512b pressing against one surface of pad 644. If a contact in the form of conductive element 510 is used, two similar points of contact will be provided on an opposing surface of pad 644. Collectively, four points of contact may thus be formed to pad 644. Providing four points of contact in this fashion may increase the robustness and reliability of a connector formed using wafers such as 630. However, any suitable number of points of contact may be used.

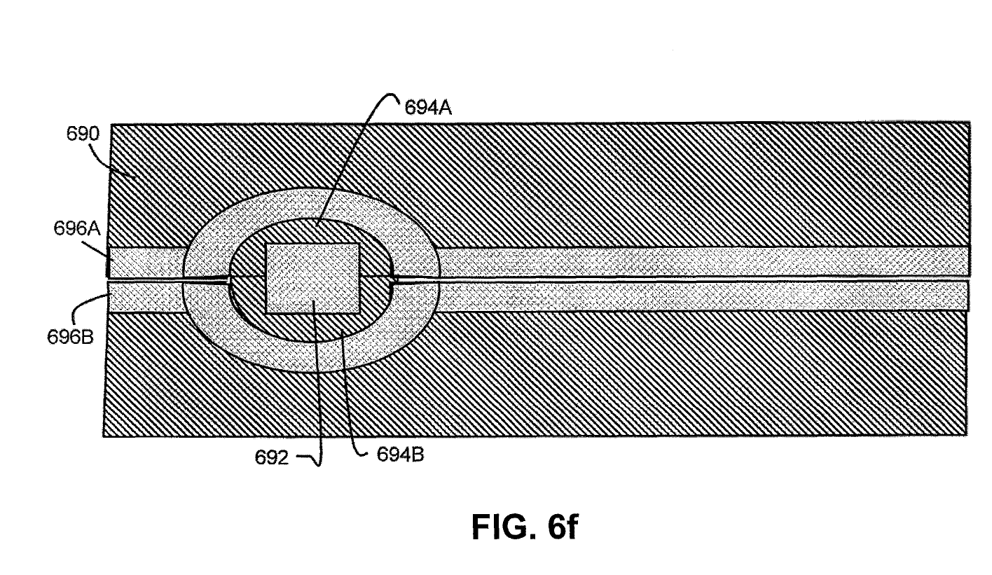

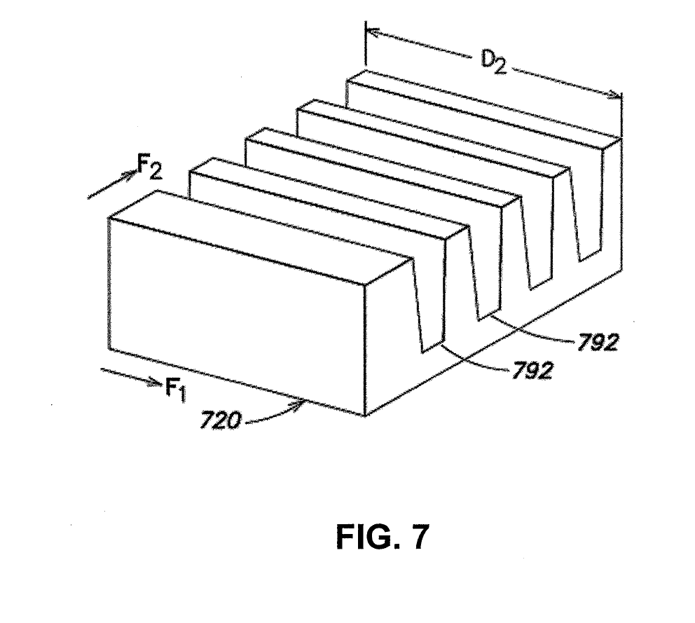

FIGS. 6c and 6d also illustrate how a wafer in the form of wafer 630 may accommodate float to accommodate rail locks or for other reasons. Wafer 630 includes a contact portion 684 that is designed for insertion into a slot, such as slot 792, in a backplane connector housing 720 (FIG. 7). Contact portion 684 is bounded by sidewalls 686 that are positioned outside of housing 720 when wafer 630 is mated with a backplane connector. In the embodiment illustrated, sidewalls 686 limit the range of float of wafer 630 relative to housing 720.

In the embodiment illustrated, wafer 630 is formed with cut-out portions 682a and 682b that provide a spacing D₁ between sidewalls 686. The dimension D₁ may be larger than the width of housing 720 represented by D₂ (FIG. 7). By making dimension D₁ larger than D₂, wafer 630 may float in direction F₁ (FIG. 7). Float in direction F₂ may also be provided by compliance of beams forming the contact elements in a backplane connector. For example, if a conductive element in the form of conductive element 510 is used, beams 512a, 512b, 512c and 512d may provide float in direction F₂.

If wafer 630 is allowed to float in direction F₁, it may be desirable that the allowed range of float not preclude alignment of the mating contact portions of conductive elements in a backplane connector and pads 644 in wafer 630. As described above in FIG. 5, the contact surfaces on the beams used to form conductive element 510 are curved to position the contact surfaces closer to the center line of conductive elements 510. As a result, when a contact element 510 is aligned with pad 644, points of contact 678a and 678b between the mating surfaces of element 510 and pad 644 may be positioned near the center of pad 644.

In the embodiment shown, the configuration of the contact element 510 ensures that points of contact 678a and 678b are spaced apart by a distance that is less that the width W₁ of pad 644. As a result, wafer 630 may float relative to contact element 510 by an amount F and points of contact 678a and 678b will still be on pad 644. In some embodiments, the difference between dimensions D₁ and D₂ will be less than the distance F, though any suitable dimensions may be used.

Turning to FIG. 6e, a strip line construction that may be achieved using a wafer as illustrated in FIG. 6a is shown. FIG. 6e shows a cross-section taken through the intermediate portions of signal conductors in wafer 630. In the example shown, the cross-section passes through intermediate portions 642 of signal conductor s640. As can be seen, the intermediate portions 642 are spaced from a ground plane formed by planar portion 612 of shield 610. The desired spacing between intermediate portions 642 and planar portion 612 may be set by insulative housing 660 that may be molded around signal conductors 640 and shield 610.

In the embodiment illustrated, the intermediate portions 642 of signal conductors 640 are embedded with insulative housing 660. Shield plate 610 is partially embedded within housing 660. However, in some embodiments, planar portion 612 may be fully embedded within housing 660.

FIG. 6f illustrates a cross-section of an alternative construction of a wafer according to some embodiments of the invention. FIG. 6f illustrates a cross-section through an intermediate portion of a signal conductor 692. In the embodiment illustrated, two shields 696a and 686b are used. Each shield has a channel 694a and 694b, respectively. The channels 694a and 694b are used to receive a signal conductor 692. The structure may be held together by an insulative housing 690 or in any other suitable way.

Housing 690 may include an insulative portion filling channels 694a and 694b not occupied by signal conductors 692. When ground plates 696a and 696b are connected to ground, they, in conjunction with signal conductor 692, form a co-axial signal path, which may have desirable signal conducting properties.

FIG. 6f illustrates a cross-section through a portion of a wafer. One wafer may contain multiple signal conductors in the form of signal conductor 692 or in any other suitable form. Each such signal conductor 692 may be disposed in recesses in shields such as 696a and 696b.

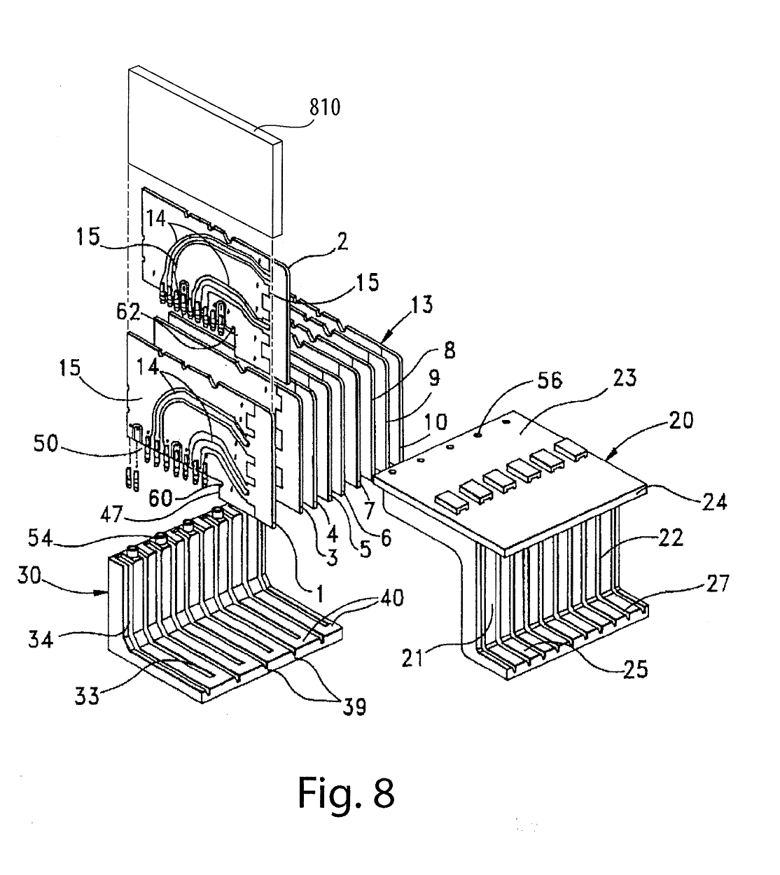

Turning to FIG. 8, an alternative embodiment of an electrical connector is illustrated. In the connector of FIG. 8, a plurality of wafers such as wafers 1 . . . 10 are formed using printed circuit board manufacturing techniques. Conductive traces acting as signal conductors and reference conductors may be patterned on substrates, such as sheets of FR4. The conductive elements may be patterned using photolithography or other suitable manufacturing technique.

The wafers 1 . . . 10 may be held in parallel within one or more organizers, such as organizers 20 and 30. However, any suitable assembly technique may be used.

In some embodiments, wafers 1 . . . 10 may be formed using a relatively small number of layers. For example, wafers 1 . . . 10 may be formed using two-layer printed circuit boards. Such a construction may not be adequately rugged for some applications.

To provide a more robust connector, shock absorbing members, of which shock absorbing member 810 is illustrated, may be positioned between adjacent wafers 1 . . . 10. Shock absorbing members may be manufactured from any suitable shock-absorbing material. In the illustrated embodiment, shock absorbing member 810 is formed from an insulative material. Examples of materials that may be used for form shock absorbing members include rubber and silicone.

Each shock absorbing member may be held in position in any suitable way. The shock absorbing members may be held in place by attachment features on the wafer organizers, by an adhesive applied to the surface of each wafer, by friction caused by force on the shock absorbing member asserted by wafers pressing against the shock absorbing member or in any other suitable way.

FIG. 9 shows a backplane connector 720 according to some embodiments of the invention. Backplane connector 720 may incorporate contacts such as contact 510 (FIG. 5). Though, in the embodiment illustrated a contact that facilitates more control over insertion force is used. Backplane connector 720 has slots, such as slot 792. Each slot is lined with multiple contacts, of which contacts 900₁ . . . 900₈ are numbered. As shown, eight contacts 900₁ . . . 900₈ per slot are used, though a connector may be constructed with any number of contacts.

In the embodiment illustrated, both signal and ground contacts have the same shape. Though, it is not a requirement that all contacts in a slot have the same shape or that all slots in a connector contain the same number or type of contacts.

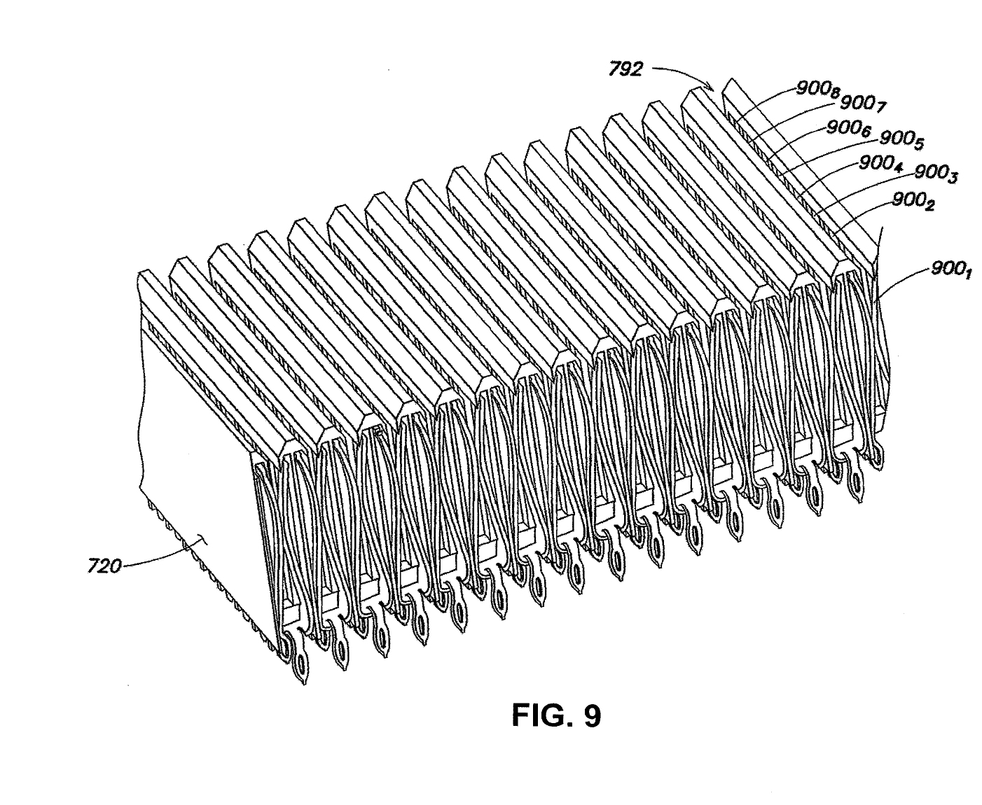

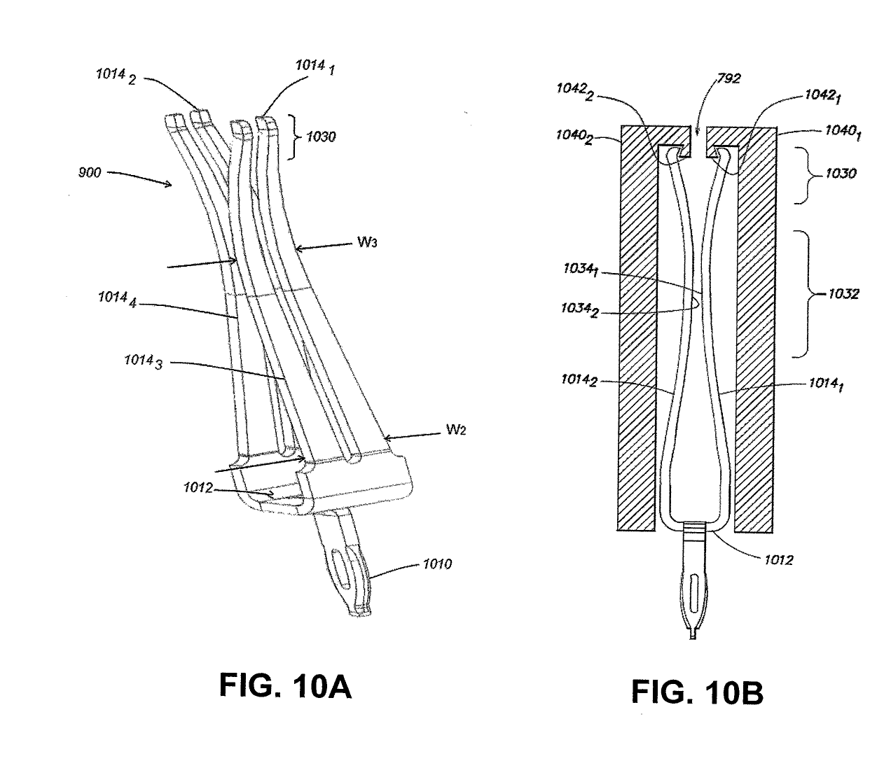

A representative contact 900 is shown in FIG. 10A. Contact 900, like contact 510 (FIG. 5), provides multiple points of contact. In the illustrated embodiment, contact 900 provides four points of contact. Though, each contact could provide more or fewer points of contact. Contact 900 also arranges the points of contact to be spaced less than the width of a pad to which contact 900 mates. Such spacing may be used to facilitate float of the connector. Also as with contact 510, contact 900 may be stamped and then formed from a sheet of flexible, conductive material, such as a copper alloy or other suitable metal.

As shown in FIG. 10A, contact 900 is formed with a base 1012. Contact tail 1010 extends from one surface of base 1012. In the embodiment illustrated, contact tail 1010 extends perpendicular to base 1012, though the specific manner in which contact tail 1010 is incorporated into contact 900 is not critical to the invention. Contact tail 1010 may have any suitable shape, though in the embodiment illustrated, contact tail 1010 is a press-fit, eye-of-the-needle contact tail.

Multiple members may also extend from base 1012 to form the mating portions of contact 900. In the embodiment illustrated, four members 1014₁ . . . 1014₄ are shown. In some embodiments, each contact will have an even number of opposing members. An even number of opposing members allows contact 900 to engage two sides of a mating contact portion from a mating connector. However, the number and type of contact members is not critical to the invention.

In the embodiment of FIG. 10A, the members 1014₁ . . . 1014₄ collectively provide four points of contact. FIG. 10B shows a side view of contact 900 in which mating surfaces 1034₁ and 1034₂ on members 1014₁ and 1014₂ are visible. Similar mating surfaces may be provided on contacts 1014₂ and 1014₃, though not visible in FIG. 10B.

As shown in FIG. 10A, members 1014₁ and 1014₂, where attached to base 1012, span a width of W₂. In a mating contact region, the width spanned by members 1014₁ and 1014₂ decreases to W₃. In the illustrated embodiment, W₃ is less than the width W₁ of a pad, such as pad 644 (FIG. 6D), to which contact 900 may make a connection. This configuration allows for “float,” as described above in connection with FIG. 6D.

Though members 1014₁ . . . 1014₄ may have any suitable shape, in the embodiment illustrated, members 1014₁ . . . 1014₄ are shaped to provide a desired insertion force as connectors are mated. As shown in FIGS. 10A and 10B, each of members 1014₁ . . . 1014₄ has a distal portion 1030. Members 1014₁ . . . 1014₄ are tapered such that the distal portions 1030 are narrow relative to other portions of the member. The tapered distal end 1030 can provide an initial low insertion force, while other portions of members 1014₁ . . . 1014₄ may be shaped to provide a higher force to retain a mating contact within contact 900 when a mating contact is fully inserted into contact 900.

FIG. 10B is a side view of contact 900 within a housing. Walls 1040₁ and 1040₂ may be portions of the housing, such as housing 720 (FIG. 9). Walls 1040₁ and 1040₂ may be spaced and shaped to provide a slot 792 that can receive a portion of a mating connector between opposing ones of the members 1014₁ . . . 1014₄. Members, such as 1014₁ and 1014₂, may contain contact surfaces, such as 1034₁ and 1034₂. In the embodiment illustrated, contact surfaces 1034₁ and 1034₂ face inwards, towards the center of slot 792 such that when a portion of a mating connector is inserted in slot 792, contact surfaces 1034₁ and 1034₂ may press against a corresponding mating contact surface on that portion.

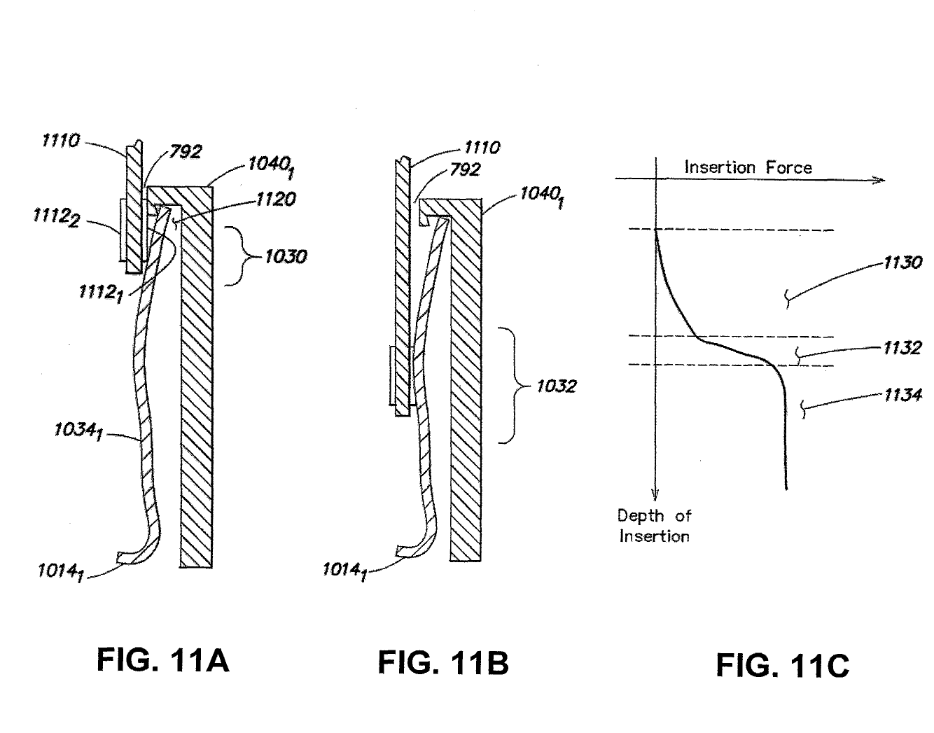

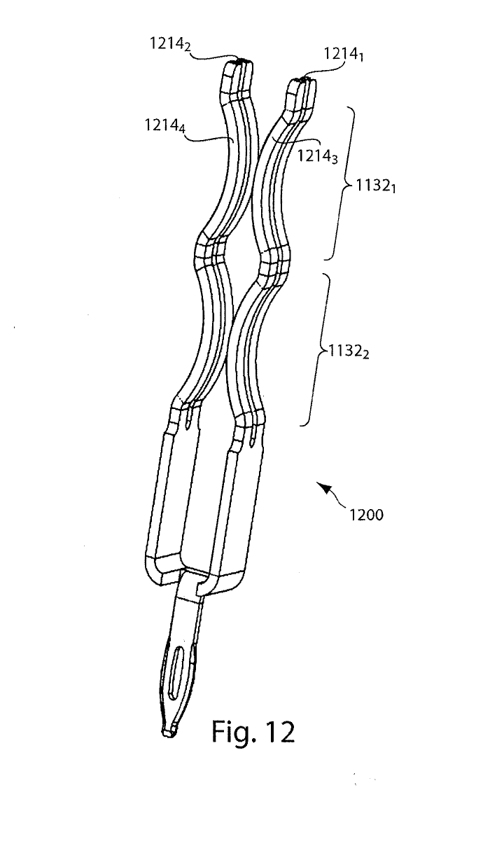

In the embodiment illustrated, the insertion force, or conversely the retention force, generated by a contact 900 may be generated by different portions of the members 1014₁ . . . 1014₄, at different times, depending on how far at portion of a mating connector is inserted into slot 792. FIGS. 11A and 11B illustrate a mating sequence and FIG. 11C is a graph depicting insertion force as a function of insertion distance.

FIG. 11A shows a portion 1110 of a mating connector being inserted in slot 792. In FIG. 11A, only member 1014₁ is shown. Embodiments of a contact may be constructed using only one member. Other embodiments may have multiple members per contact. In embodiments in which a contact is formed with multiple members, additional members may operate during a mating sequence in the same way as member 1014₁. Accordingly, only one member is illustrated for simplicity.

Portion 1110 may be a portion of any suitable connector. For example, portion 1110 may be a forward portion of a wafer 130 (FIG. 1d) or 630 (FIG. 6A). Portion 1110 may contain one or more mating contact portions that engage members, such as member 1014₁. In the embodiment illustrated, mating contact portions are pads, of which pads 1112₁ and 1112₂ are shown. Here, pads 1112₁ and 1112₂ form opposing surfaces of one conductive element, though any suitable configuration of mating contact portions may be used.

FIG. 11A illustrates the position of portion 1110 at the start of a mating sequence. As portion 1110 enters slot 792, it contacts distal portion 1030. Because distal portion 1030 is tapered to be relatively thin, it is compliant and therefore easily deflected by force exerted on distal portion 1030 by portion 1110 when portion 1110 is first inserted. In the embodiment shown, distal portion 1030 is initially spaced from wall 1040₁ by a space 1120, creating a space into which distal portion 1030 may be deflected while still moving freely.

To prevent damage to distal portion 1030 during insertion of portion 1110, walls 1040₁ and 1040₂ may have retaining features that prevent the distal ends 1030 of members 1014₁ . . . 1014₄ from extending into slot 792, which can cause stubbing when a mating portion of a connector is inserted into slot 792. In the embodiment illustrated, lips 1042₁ and 1042₂ (FIG. 10B) adjacent to an opening into slot 792 act as retaining features. However, retaining features of any suitable construction may be used.

FIG. 11B illustrates the position of portion 1110 at a later time in the mating sequence. In the configuration illustrated, portion 1110 has been inserted into slot 792 a sufficient distance that pad 1112₁ engages arched portion 1032. In this configuration, distal end 1030 of member 1014₁ has been pressed through space 1120 and presses against a surface that stops its motion. In the embodiment illustrated, that surface is a portion of wall 1040₁. However, any suitable structure may be used to restrain motion of distal end 1030.

In the embodiment illustrated, distal end 1030 rests in a corner of wall 1040₁. In this configuration, distal end is restrained from moving away from slot 792. Member 1014₁ is also restrained from moving along wall 1040₁ as portion 1110 presses against arched portion 1032. Consequently, as portion 1110 presses against arched portion 1032, member 1014₁ is placed in compression. Because placing arched portion 1032 in compression requires more force than deflecting distal portion 1030, the insertion force increases as portion 1110 is inserted to the point that it engages arched portion 1032.

The insertion force during such a mating sequence is shown in FIG. 11C. In region 1130, portion 1110 initially makes contact with member 1014₁, resulting in a relatively low force. Because member 1014₁ is tapered, the force increases non-linearly as wider, and therefore stiffer, segments of member 1014₁ are deflected as the insertion distance increases.

Thus, region 1130 indicates a low, but increasing insertion force as portion 1110 is initially inserted. The tapered configuration of member 1014₁ may be used in connectors for which a low initial insertion force is desired, such as in embodiments in which float is desired. With low initial insertion force, two mating connectors may be easily aligned at the outset of the mating sequence.

As portion 1110 is inserted further, the insertion force increases, as depicted by region 1132. Region 1132 corresponds to the portion 1110 pressing against arched portion 1032. As can be seen, in region 1132 the insertion force increases at a greater rate than in region 1130.

When portion 1110 is inserted in slot 792 until the forward edge reaches the apex of arched portion 1032, further insertion does not further compress arched portion 1032. At that point, the insertion force does not increase, even if portion 1110 is further inserted. However, in the embodiment illustrated, mating surface 1034₁ (FIG. 10B) presses against surface 112, with the force illustrated in region 1134. As a result, there is a relatively high contact force, corresponding to the force illustrated in region 1134. This relatively high contact force may retain portion 1110 in place and may provide a good electrical connection between the mating contact portions. However, because this high contact force creates a high insertion force over only a small portion of the insertion sequence, mechanical structures to align mating connectors and generate the required insertion force may be simplified.

FIGS. 11A, 11B and 11C illustrate that contact 900 may be shaped to provide a desired force profile during a mating sequence. By omitting or incorporating a taper or otherwise controlling the dimensions of the distal end 1030, the initial mating force can be controlled. Be controlling the dimensions of a central portion, such as arched portion 1032, as well as the location at which distal end 1030 becomes restrained, the retention force of the contact may be controlled.

FIG. 12 illustrates an alternative embodiment of a contact 1200 with a different shape to provide a different insertion force profile. Contact 1200, like contact 900 includes four elongated members 1214₁ . . . 1214₄. In the embodiment illustrated, each of the each of the elongated members contains two arched portions, 1132₁ and 1132₂. Such a configuration may provide two stepped increases in insertion force as a mating connector portion engages contract 1200. The first stepped increase may occur as the mating contact portion is inserted to the point that the leading edge engages the mating arched portion 1132₁. A second stepped increase may occur as the leading edge engages arched portion 1132₂. In the embodiment illustrated, each arched portion 1132₁ and 1132₂ is approximately the same size such that each step increase in insertion force may be approximately equal. However, the invention is not limited in that regard and any suitable configuration may be used to provided a desired insertion force profile.

Accordingly, the specific configuration of the elongated members of a contact is not a limitation of the invention. For example, though elongated members with rounded arches are illustrated, the invention is not so limited. An arch may be formed with straight segments that join at a defined point.

While particular embodiments have been chosen to illustrate the invention, it will be understood by those skilled in the art that various changes and modifications can be made therein without departing from the scope of the invention as defined in the appended claims.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An electronic assembly comprising:
a) a first connector comprising:
i) a plurality of first conductive elements, each first conductive element comprising a first pad and a second pad;
ii) a plurality of mating segments, each mating segment having opposing first and second surfaces, wherein a first pad of each first conductive element is disposed on a first surface and a second pad of each first conductive element is disposed on a second surface of a segment of the plurality of segments; and
b) a second connector comprising a plurality of second conductive elements, each second conductive element positioned to engage a corresponding first conductive element, and each second conductive element comprising at least a first, second, third and fourth contact surfaces, wherein the first and second contact surfaces are adapted and arranged to engage a first pad of the corresponding first conductive element and the third and fourth contact surfaces are adapted and arranged to engage a second pad of the corresponding first conductive element.

2. The electronic assembly of claim 1, wherein the first, second, third and fourth contact surfaces are disposed on ends of first, second, third and fourth beams, respectively, and the first beam has a length different than a length of the second beam and the third beam has a length different than a length of the fourth beam.

3. The electronic assembly of claim 2, wherein the first pad and the second pad of each first conductive element comprise opposing sides of a single conducting member.

4. The electronic assembly of claim 1, wherein:
the first connector comprises a plurality of subassemblies and each of the plurality of mating segments is disposed on a subassembly; and
the second connector comprises a housing having a plurality of slots, each slot being adapted and configured to receive a mating segment of one subassembly.

5. An electronic assembly comprising:
a) a first connector comprising a plurality of wafers aligned in parallel, each wafer comprising:
i) an array of first contacts, each first contact comprising a first pad and a second pad;
ii) an insulating member having opposing first and second surfaces, wherein a first pad of each first contact is disposed on the first surface and a second pad of each conductive element is disposed on the second surface; and
b) a second connector comprising:
i) a housing having a plurality of slots, each slot adapted and configured to receive an insulating member of a wafer of the plurality of wafers;
ii) a plurality of second contacts, each second contact positioned within a slot of the plurality of slots to engage a corresponding first contact, and each second contact comprising at least a first, second, third and fourth beams having respective first, second, third and fourth contact surfaces thereon, wherein the first and second contact surfaces are adapted and configured to engage a first pad of the corresponding first contact and the third and fourth contact surfaces are adapted and arranged to engage a second pad of the corresponding first contact, and the first beam has a length different than a length of the second beam and the third beam has a length different than a length of the fourth beam.

6. The electronic assembly of claim 5, wherein each of the plurality of second contacts comprises an integral member formed from one sheet of metal.

7. A wafer for an electrical connector, comprising of:
first and second shielding members defining first and second grounding planes;
at least one signal conductor disposed between said first and second shielding members, said signal conductor having a first end terminal adapted for connection with a printed circuit board, and a second end terminal adapted for engaging a mating connector.

8. A wafer according to claim 7, wherein
at least one of said first and second shield members comprises at least one integral grounding pin extending therefrom.

9. A wafer according to claim 7, wherein
said first and second shields include first and second channels, respectively;
said first and second shields are positioned to align said first and second channels; and
said signal conductor is disposed within said first and second channels.

10. A wafer according to claim 9, further comprising at least one insulating member separating said signal conductor from said first and second shields.

11. A wafer according to claim 7, wherein
at least a portion of said dielectric housing is cutout, thereby exposing one of said first and second grounding planes.

12. A wafer according to claim 11, wherein
said cutout exposing said second end terminal of said signal conductor.

13. A wafer according to claim 12, wherein
said first end terminal is a press fit pin; and said second end terminal is a pad.

14. A wafer according to claim 7, further comprising
a dielectric housing substantially encapsulating said first and second shielding members.

15. A wafer according to claim 14, wherein
said dielectric housing includes a plurality cutouts exposing said first and second grounding planes

16. A wafer according to claim 15, wherein
said plurality of cutouts comprise a plurality of slots adapted to receive terminals of a mating connector.

17. A wafer according to claim 14, wherein
said first end terminal is a press fit pin; and
said second end terminal is a socket.

18. An electronic assembly comprising:
a) a first connector having a guidance member, the guidance member having an outwardly facing surface comprising at least one tapered segment and at least one body segment, the body segment having a first contour; and
b) a second connector having a housing adapted to mate with the first connector, the housing having an inwardly facing surface comprising a recess, the recess having a second contour complementary to the first contour, the second connector housing adapted and arranged to position the body segment adjacent the recess when the first connector is mated to the second connector.

19. The electronic assembly of claim 18, additionally comprising:
c) a backplane, wherein the second connector is attached to the backplane; and
d) a fluid connection extending through the backplane adjacent the second connector.

20. The electronic assembly of claim 18, wherein the first connector comprises:
i) an organizer; and
ii) a plurality of wafers coupled to the organizer,
wherein the guidance member is attached to the organizer.

21. The electronic assembly of claim 20, wherein:
the second connector housing comprises opposing first and second side walls adapted to receive wafers there between and an end wall, transverse to the first and second sidewalls; and
the inwardly facing surface comprises a surface of the end wall.

22. The electronic assembly of claim 18 wherein the second connector housing is adapted and arranged to position the body segment within the recess when the first connector is mated to the second connector.

23. The electronic assembly of claim 18, wherein:
the guidance member has a relieved segment adjacent the body portion and the inwardly facing surface has a relieved portion adjacent the recess; and
the second connector housing is adapted and arranged to:
position the body segment within the recess as the first connector is being mated to the second connector; and
position the relieved portion of the guidance member in the recess and the body portion in the relieved portion of the inwardly facing surface when the first connector is mated to the second connector.

24. The electronic assembly of claim 23, further comprising:
c) a daughter card, wherein the first connector is mounted to the daughter card;
d) a backplane, wherein the second connector is mounted to the backplane;
e) at least one rail adapted and arranged to receive the daughter card; and
f) at least one rail lock adapted and arranged to secure the daughter card to the at least one rail.

25. An electronic assembly, comprising:
a) a first connector having:
i) a housing having a plurality of parallel slots therein; and
ii) a plurality of conductive elements disposed adjacent each of the plurality of slots, each of the plurality of conductive elements having a mating contact portion within the slot;
b) a second connector comprising a plurality of wafers held in parallel, each wafer comprising:
i) a housing having a mating segment adapted to fit within a slot of the plurality of slots;
ii) a plurality of conductive elements, each conductive element having a mating contact portion exposed in at least one surface of the mating segment, the mating contact portions adapted and arranged to engage a mating contact portion within the first connector,
wherein each mating segment is adapted and arranged to allow float of the second connector relative to the first connector.

26. The electronic assembly of claim 25, wherein the housing of the first connector has a first dimension along the plurality of parallel slots and each of the mating segments is bounded by sidewalls spaced by a second dimension, larger than the first dimension.

27. An electrical connector comprising:
a) a plurality of printed circuit boards, each printed circuit board comprising a plurality of conductive elements disposed thereon;
b) a support member holding the plurality of printed circuit boards in parallel; and
c) a plurality of shock absorbing members, each shock absorbing member disposed between adjacent printed circuit boards of the plurality of printed circuit boards.

28. An electrical connector comprising:
a) a housing having an opening therein, the housing having a surface that bounds, at least in part, the opening; and
b) at least one contact having a beam disposed within the opening, the beam having a proximal end coupled to the housing and a distal end disposed adjacent the surface and a central, arched portion, the arched portion having an outer surface positioned in the opening.

29. The electrical connector of claim 28, wherein the beam is tapered to decrease in width between the arched portion and the distal end.

30. The electrical connector of claim 26, wherein:
i) the beam is a first beam and the surface is a first surface;
ii) the housing has a second surface that bounds, at least in part, the opening, the second surface being opposite the opening from the first surface; and
iii) the contact has a second beam disposed within the opening, the second beam having a proximal end coupled to the housing and a free distal end disposed adjacent the second surface, the second beam having a central, arched portion, the arched portion having an outer surface positioned in the opening opposing the outer surface of the first beam.

31. The electrical connector of claim 30, wherein the contact further comprises:
A) a third beam disposed within the opening parallel to the first beam, the third beam having a proximal end coupled to the housing and a free distal end disposed adjacent the surface and a central, arched portion, the arched portion having an outer surface positioned in the opening; and
B) a fourth beam disposed within the opening parallel to the second beam, the fourth beam having a proximal end coupled to the housing and a free distal end disposed adjacent the second surface, the fourth beam having a central, arched portion, the arched portion having an outer surface positioned in the opening and opposing the outer surface of the third beam.

32. The electrical connector of claim 29, wherein:
i) the housing has a first lip and a second lip; and
ii) the distal ends of the first and third beam are movably restrained between the first lip and the first surface; and
iii) the distal ends of the second and fourth beams are movably restrained between the second lip and the second surface.

33. The electrical connector of claim 32, wherein the opening is shaped to receive a mating portion from a mating connector, the mating portion being inserted along a path extending into the opening, wherein the arched portions of the first, second, third and fourth beams extend into the path.

34. The electrical connector of claim 28, wherein the opening comprises a slot and the at least one contact comprises a plurality of like contacts disposed along the slot.

35. The electrical connector of claim 33, wherein the housing comprises a lip disposed along the slot and the distal end of each of the plurality of contacts engages the lip.

36. A contact for an electrical connector comprising:
a) a base;
b) a contact tail extending in a first direction from the base; and
c) a first beam and a second beam extending from the base in a second direction,
i) the first beam having a first central curved portion with a first mating contact surface and a first tapered portion extending from the first curved portion;
ii) the second beam having a second central curved portion with a second mating contact surface and a second tapered beam extending from the second curved portion,
wherein the first mating contact surface opposes the second mating contact surface.

37. The contact of claim 36, wherein the base, contact tail, first beam and second beam are stamped from a single sheet of conducting material.

38. The contact of claim 36, further comprising:
d) a third beam and a fourth beam extending from the base in a second direction,
i) the third beam having a third central curved portion with a third mating contact surface and a third tapered portion extending from the third curved portion;
ii) the fourth beam having a fourth central curved portion with a fourth mating contact surface and a fourth tapered beam extending from the fourth curved portion,
wherein the third mating contact surface opposes the fourth mating contact surface.

39. The contact of claim 38, wherein the first beam is aligned with the third beam and the second beam is aligned with the fourth beam.

40. The contact of claim 38, wherein the first contact surface and the third contact surface define a first side of a mating region and the second contact surface and the fourth contact surface define a second side of a mating region.

41. A method of assembling an electronic assembly comprising an electrical connector and a mating electrical connector, the method comprising inserting a portion of the mating electrical connector into an opening in the electrical connector, the portion having a mating contact surface, the inserting comprising:
a) as a first length of the portion is inserted, pressing the portion against an elongated conducting member within the connector to deflect an end of the elongated conducting member; and
b) as a second length of the portion is inserted after the first length is inserted, restraining the end of the elongated conducting member and pressing the portion against a central segment of the elongated conducting member.

42. The method of claim 41, wherein pressing in the act a) comprises pressing against a first insertion force, and pressing in the act b) comprises pressing with a second insertion force, the first insertion force being less than the second insertion force.

43. The method of claim 41, wherein pressing in the act b) comprises placing the elongated conducting member in compression.

44. The method of claim 41, wherein inserting in the act b) comprises positioning the mating contact surface in contact with the central segment of the elongated conducting member.

45. The method of claim 41, wherein the restraining in the act b) comprises bringing the end into contact with a wall of a housing of the electrical connector.

46. The method of claim 41, wherein the elongated conducting member is a first elongated conducting member and the act a) further comprises pressing the portion against a second elongated conducting member within the connector to deflect an end of the second elongated conducting member in a direction opposite to the direction in which the end of the first elongated conducting member is deflected.

47. The method of claim 46, wherein the act b) further comprises restraining the end of the second elongated conducting member and pressing the portion against a central segment of the second elongated conducting member to generate opposing forces on opposite sides of the mating contact surface.
